(19) United States
(12) Patent Application Publication
(10) Pub. No.: US 2026/0295916 A1
(43) Pub. Date: Oct. 1, 2026

(54) METHOD FOR PRODUCING A SINGLE- OR MULTI-LAYERED FILM, SINGLE- OR MULTI-LAYERED, EXTRUDED, SIMULTANEOUSLY BIAXIALLY STRETCHED AND THERMOFIXED FILM AND CORRESPONDING USES

(71) Applicant: KUHNE ANLAGENBAU GMBH, St. Augustin/Menden (DE)

(72) Inventor: Jürgen Michael SCHIFFMANN, Hennef (DE)

(73) Assignee: KUHNE ANLAGENBAU GMBH, St. Augustin/Menden (DE)

(21) Appl. No.: 19/478,668

(22) PCT Filed: Apr. 10, 2024
(86) PCT No.: PCT/EP2024/059671

§ 371 Date: Oct. 24, 2025

(30) Foreign Application Priority Data
Apr. 28, 2023 (DE) 10 2023 111 077.2

(51) Int. Cl. B29C 48/08; B29C 48/00; B29C 48/18; B29K 23/00; B29K 29/00; B29L 7/00; B29L 9/00; B29L 31/00; B32B 27/08; B32B 27/30; B32B 27/32; B65D 65/40

(52) U.S. Cl. CPC B29C 48/08; B29C 48/0017; B29C 48/0018; B29C 48/18; B32B 27/08; B65D 65/40; B29K 2023/0608; B29K 2023/086; B29K 2023/12; B29K 2029/04; B29L 2007/008; B29L 2009/00; B29L 2031/712; B32B 27/306; B32B 27/32; B32B 2250/24; B32B 2250/44; B32B 2439/70

(57) ABSTRACT

A single- or multi-layered, extruded, simultaneously biaxially stretched and thermofixed films with a first polyethylene having a density of greater than 0.940 g/cm³, which can be used, for example, as packaging materials, in particular for foodstuffs, a method for producing the same and their use, for packaging a foodstuff.

### CROSS-REFERENCE TO RELATED APPLICATIONS

The present application is the U.S. National Phase entry of International Patent Application No. PCT/EP2024/059671 filed Apr. 10, 2024, which claims priority to German Patent Application No. 102023111077.2 filed Apr. 28, 2023, the contents of which are hereby incorporated by reference into this application.

### TECHNICAL FIELD

The present application relates to single- or multi-layered, extruded, simultaneously biaxially stretched and thermofixed films which can be used, for example, as packaging materials, in particular for foodstuffs, a method for their production and their use, preferably for packaging a foodstuff.

### BACKGROUND

In the course of improving the reusability or recyclability of plastic-based packaging materials, so-called monomaterials, i.e. single-origin materials consisting of only one type of plastic, are ideally used. However, the materials available to date often reach their technical limits for more complex applications with a higher requirement profile, as is the case with food packaging. This is because no single plastic fulfills all the properties that are required in total to achieve ideal packaging properties. Typically, each type of plastic only fulfils one or two of the following properties, such as barrier properties against water, water vapor, aroma components or gases such as oxygen, sufficient rigidity, puncture resistance, delamination resistance and other mechanical properties, good heat resistance, good sealing properties, attractive optical properties such as low haze and good printability.

This has sometimes led to complex multi-layered structures with up to 13 layers and a large number of functional polymers, which makes it difficult or even impossible to recycle the resulting packaging materials.

As a result, there is still a lack of solutions for recyclable plastic-based packaging materials, especially for food, which preferably fulfill all of the following requirements: Stiffness, heat resistance, oxygen, gas and aroma barrier, low to no shrinkage.

### SUMMARY

It is therefore an object of the present disclosure to provide a method for producing a single- or multi-layered film and a single- or multi-layered, extruded, simultaneously biaxially stretched and thermofixed film which can be produced thereby, which is suitable as a packaging material for foodstuffs or can be processed into a suitable packaging material and has improved recyclability. It is also an object to provide corresponding uses.

### Definitions and Measuring Methods of the Present Disclosure

“extruding”: passing at least one type of molten thermoplastic material through a die to form a film (sheet material with a low thickness of <3 mm) as the thermoplastic material re-emerges from the die, the die preferably being a ring or slot die.

“after extruding” means temporally and/or spatially immediately after the film exits the die, as far as technically feasible.

“before stretching” means temporally and/or spatially before the simultaneous application of forces in the machine direction and in the transverse direction to the film for the purpose of biaxial stretching.

“time at which stretching begins” means the first time point or point of time at which the force in the machine direction and the force in the transverse direction act simultaneously on the film for the purpose of biaxial stretching.

“after stretching” means temporally and/or spatially immediately after the end of the simultaneous application of the forces in the machine direction and in the transverse direction on the film for the purpose of biaxial stretching, insofar as technically feasible.

“before thermofixation” means temporally and/or spatially before the film is heated to the temperature at which thermofixation is carried out (third temperature (T3)).

In the context of the present disclosure, “relaxing” or “relaxation” means the controlled shrinking back of the film in MD and/or TD. Controlled re-shrinking in MD is achieved by using different withdrawal or take-off speeds, i.e. the film withdrawal or take-off downstream in the relaxation process runs or pulls at a lower speed than the film withdrawal upstream in the process. In TD, controlled re-shrinking is achieved by reducing the film width between the two film withdrawals. An example of a relaxation process for extruded and stretched single- or multi-layered films is known to the skilled person from Savic, Z., Savic. I, “Sausage Casings”, VICTUS Lebensmittelindustriebedarf Vertriebsgesellschaft m. b. H., Vienna, 1st edition, June 2002, chapter 7, subchapter 4.2, pages 267 to 270, in particular FIG. 7-13a and 7-13b.

### Density: Measured According to DIN EN ISO 1183-1:2019-09

Temperature of the film (e.g. during stretching, thermofixing or relaxing): is the temperature of the film surface, preferably measured without contact using an IR temperature sensor.

Shrinkage (or also referred to as hot shrinkage): measured in water at 90° C., preferably within 1 second after immersion, but at least within 10 seconds after immersion. In accordance with the present disclosure, the sample is immersed in water at 90° C. for a predetermined period of time, in particular the aforementioned period of time, to determine the shrinkage (or hot shrinkage) and immediately cooled to room temperature with water after removal. The length of a pre-marked section after this treatment is measured and related to the measured length of the same section of the sample before the treatment. The resulting length ratio (“shrunk” to “not shrunk”), expressed as a percentage, defines the shrinkage. Depending on the direction of the length measurement, the shrinkage results in the longitudinal (MD) and transverse (TD) directions. The total shrinkage is calculated by adding the shrinkage in the longitudinal and transverse directions. Multiple determinations, such as triple or quintuple determinations, of the length measurements, and the formation of the corresponding mean values from these, advantageously increase the accuracy of the determination. According to the present disclosure, the shrinkage and the total shrinkage can be determined in particular in accordance with ASTM D2732-14, 2020 edition, Apr. 14, 2020.

Heat deflection temperature: is the heat deflection temperature, measured according to ASTM D648-18.

Strength: tensile properties (DIN EN ISO 527-1:2019-12, edition 2019-12, and DIN EN ISO 527-2:2012-06, edition 2012-06), flexural properties (3-point method) (ASTM D0790-17, edition Jul. 24, 2017), or flexural properties (4-point method) (ASTM D6272-17el, edition Jul. 14, 2020).

Stiffness: measured according to DIN EN ISO 527-1:2019-12, edition 2019-12, and DIN EN ISO 527-2:2012-06, edition 2012-06.

Transparency/opacity/clarity: measured according to ASTM D1003-21; Jun. 7, 2021 edition.

Printability: measured according to DIN 16500-2:2018-09, edition 2018-09, or defined as polarity in the form of surface tension, given in the unit Dyn/cm (=10-3 N/m).

Sealability: e.g. sealing/welding properties of films/hot tack test of films: measured according to DIN 55571-2:2021-07

### Sealing Seam Strength: Measured According to DIN 55529:2012-09

Sealing temperature: Is the sealing temperature=temperature which the material to be sealed exhibits during sealing, measured as the temperature of the film, as defined above.

Sealing/Heat Sealing: Is the bonding of thermoplastic coatings on carrier materials or of purely thermoplastic materials under the effects of time, (contact) pressure and temperature, but the carrier materials are not melted.

The following length definitions apply in the context of this present disclosure (in each case in relation to the machine direction or the transverse direction):
L0: =length of a predetermined section of the film before stretching;
L1: =length of the same section of the film after stretching and before relaxation;
L2: =length of the same section of the film after stretching and after relaxation.

Stretch factor: stretch factor V=length L1 of a predetermined section of the film after stretching and before relaxation divided by the length L0 of the same section of the film before stretching; (V=L1/L0). The stretch factor V, in which the lengths L0 and L1 are determined in the machine direction MD, is also referred to as the stretch factor V_{MD} according to the present disclosure. The stretch factor V, in which the lengths L0 and L1 are determined in the transverse direction TD, is also referred to as stretch factor V_{TD} according to the present disclosure.

Relaxation factor: relaxation factor R=1−(length L2 of a predetermined section of the film after stretching and after relaxation divided by the length L1 of the same section of the film after stretching and before relaxation); (R=1−(L2/L1)). The relaxation factor R, which is calculated as indicated above and in which the lengths L2 and L1 are determined in the machine direction MD, is also referred to as the relaxation factor R_{MD} in the machine direction MD according to the present disclosure. The relaxation factor R, which is calculated as indicated above and in which the lengths L2 and L1 are determined in the transverse direction TD, is also referred to according to the present disclosure as relaxation factor R_{TD} in the transverse direction TD.

After carrying out the two method steps of stretching and thermofixation, here with relaxation, this results in a residual stretching or residual elongation in the film. A residual stretch factor RV can be determined, which is defined in detail below and which is based on the ratio of a length L2 of a section of the film after stretching and after thermofixation including relaxation to a length L0 of the same section before stretching and before relaxation.

Residual stretch factor: residual stretch factor RV=length L2 of a predetermined section of the film after stretching and after relaxation divided by the length L0 of the same section of the film before stretching and before relaxation; RV=L2/L0. According to the present disclosure, the residual stretch factor RV, in which the lengths L2 and L0 are determined in the machine direction MD, is also referred to as the residual stretch factor RV_{MD}. The residual stretch factor RV, in which the lengths L2 and L0 are determined in the transverse direction TD, is also referred to as the residual stretch factor RV_{TD} according to the present disclosure.

“simultaneously biaxially stretched film”: means a film that has been stretched simultaneously in both the machine direction and the transverse direction.

“Stable method” or “stable process”: method or process that allows continuous operation (execution of the method or process) and by which a film can be produced that is usable for the intended application. Accordingly, “unstable” does mean not “stable” in the above sense.

Further definitions which apply in the context of the present disclosure, in particular to the subject-matter and embodiments of the present disclosure defined in the claims and in the description, are those listed below. Hereby, for the purposes of the present disclosure, the numeral terms “first”, “second”, “third”, etc., such as “second polyethylene” or “second polyethylene PE2” used in the designation of the polymers represent a mere designation of the respective polymer as defined below and do not imply a disclosure of a specific number or sequence of polymers. For example, according to the present disclosure, the statement “the film contains a third polyethylene PE3” does not mean that the film also contains or must contain a first polyethylene PE1 and a second polyethylene PE2. Rather, it merely means that the film contains the third polyethylene PE3 as defined below, regardless of other components, if any. Therefore, the “third polyethylene” could also have any other designation, such as “polyethylene C”. The same applies to the “first polyethylene”, the “second polyethylene”, the “first polypropylene”, the “second polypropylene”, the “third polypropylene”, the “second polymer” and the “third polymer” as defined below. The limitations of said polymers set forth below by definition also apply regardless of whether the respective polymer is used with the indefinite or definite article in the description and/or claims.

Polyethylene (PE): Is a thermoplastic polymer with the repeating unit [C₂H₄] (molecular formula) with the structural formula that can be produced by chain polymerization of ethene:

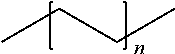

First polyethylene (PE1) (=high density polyethylene (HDPE)): is a polyethylene (PE) with a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09. According to the present disclosure, the first polyethylene (PE1) comprises a polymer type or a mixture of several polymer types (e.g. with different chain lengths) of the polyethylene type. If the first polyethylene (PE1) consists of a mixture of several types of polymers of the polyethylene type, the above-mentioned density ranges apply to the mixture after homogenization thereof.

Second polyethylene (PE2): is a polyethylene (PE) with a density of less than 0.940 g/cm³, preferably less than 0.920 g/cm³, and greater than 0.870 g/cm³, measured according to DIN EN ISO 1183-1:2019-09, preferably a sealable polyethylene or a polyethylene which is suitable for forming a sealable layer. According to the present disclosure, the second polyethylene (PE2) comprises one polymer type or a mixture of several polymer types (e.g. different chain lengths) of the polyethylene type. If the second polyethylene (PE2) consists of a mixture of several types of polymers of the polyethylene type, the above-mentioned density ranges apply to the mixture after homogenization thereof. The second polyethylene (PE2) is not identical to the first polyethylene (PE1).

Third polyethylene (PE3): is a polyethylene (PE) with a density which is lower than the density of the first polyethylene (PE1) and higher than the density of the second polyethylene (PE2), in each case measured according to DIN EN ISO 1183-1:2019-09. According to the present disclosure, the third polyethylene (PE3) comprises one polymer type or a mixture of several polymer types (e.g. different chain lengths) of the polyethylene type. If the third polyethylene (PE3) consists of a mixture of several types of polymers of the polyethylene type, the above-mentioned density ranges apply to the mixture after homogenization thereof. The third polyethylene (PE3) is not identical to the second polyethylene (PE2) and not identical to the first polyethylene (PE1).

Polypropylene (PP): is a thermoplastic polymer with the repeating unit [C₃H₆] (molecular formula) with the following structural formula that can be produced by chain polymerization of propene:

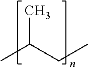

First polypropylene (PP1): is a polypropylene (PP) with a heat deflection temperature (=deflection temperature) of greater than 75° C., preferably greater than 85° C., in particular greater than 95° C., measured according to ASTM D648-18; and preferably with a density of greater than 0.895 g/cm3 and less than 0.920 g/cm³, preferably greater than 0.899 g/cm³, and less than 0.910 g/cm³, measured according to DIN EN ISO 1183-1:2019-09. According to the present disclosure, the first polypropylene (PP1) comprises one polymer type or a mixture of several polymer types (e.g. different chain lengths) of the polypropylene type. If the first polypropylene (PP1) consists of a mixture of several polymer types of the polypropylene type, the above ranges for the heat deflection temperature and preferably also for the density apply to the mixture after homogenization thereof.

Second polypropylene (PP2): is a polypropylene (PP) having a heat deflection temperature of less than 75° C., preferably less than 65° C., in particular less than 55° C., measured according to ASTM D648-18, preferably a sealable polypropylene or a polypropylene suitable for forming a sealable layer. According to the present disclosure, the second polypropylene (PP2) comprises one polymer type or a mixture of several polymer types (e.g. different chain lengths) of the polypropylene type. If the second polypropylene (PP2) consists of a mixture of several types of polymers of the polypropylene type, the above ranges for the heat deflection temperature apply to the mixture after homogenization thereof.

Third polypropylene (PP3): is a polypropylene (PP) having a heat deflection temperature which is lower than the heat deflection temperature of the first polypropylene (PP1) and higher than the heat deflection temperature of the second polypropylene (PP2), in each case measured according to ASTM D648-18. According to the present disclosure, the third polypropylene (PP3) comprises one polymer type or a blend of several polymer types (e.g. different chain lengths) of the polypropylene type. If the third polypropylene (PP3) consists of a mixture of several types of polypropylene-type polymers, the above-mentioned ranges for the heat deflection temperature apply to the mixture after homogenization thereof.

Second polymer (PM2): is a polymer (preferably a polyolefin) which is preferably sealable, in particular heat-scalable, and preferably a polyethylene (PE), a polypropylene (PP), an ethylene-vinyl acetate copolymer (EVA), an ionomer (IO), an ethylene-methyl methacrylate copolymer (EMMA), an ethylene-methacrylic acid copolymer (EMA). If the second polymer (PM2) is a polyolefin, which is preferred, it is referred to as the second polyolefin (PO2) according to the present disclosure.

Third polymer (PM3): is a polymer (preferably a polyolefin) which is preferably non-sealable, more preferably non-heat-sealable, in particular has a sealing temperature which is higher than the sealing temperature of the second polymer (PM2) (preferably the second polyolefin (PO2)), and preferably comprises or consists of a polyethylene (PE) and/or a polypropylene (PP) or any mixture thereof. When the third polymer (PM3) is a polyolefin, which is preferred, it is referred to as the third polyolefin (PO3) according to the present disclosure.

Polyethylene terephthalate (PET): polyethylene terephthalate which can be obtained by polycondensation of terephthalic acid (1,4-benzenedicarboxylic acid) and ethylene glycol (1,2-dihydroxyethane).

Polyvinylidene chloride (PVDC): is a thermoplastic formed from vinylidene dichloride (1,1-dichloroethene) analogous to PVC. PVDC decomposes near the melting point of approx. 200° C.

Polyamide (PA): is a material selected from a group, consisting of PA made from ε-caprolactam or poly (&-caprolactam) (PA6), PA made from hexamethylenediamine and adipic acid or polyhexamethylene adipinamide (PA6.6), PA made from 8-caprolactam and hexamethylenediamine/adipic acid (PA6.66), PA made from hexamethylenediamine and dodecanedioic acid or polyhexamethylenedodecanamide (PA6.12), PA made from 11-aminoundecanoic acid or polyundecanamide (PA11), PA made from 12-laurinlactam or poly (ω-laurinlactam) (PA12), or a mixture of these PAs or a mixture of these PAs with amorphous PA or with other polymers. The general notation PAx.y is synonymous with PAx/y or PAxy.

Ethylene-vinyl alcohol copolymer (EVOH): is a fully saponified copolymer made from ethene and vinyl acetate with the repeating units [C₂H₄O] and [C₂H₄] (molecular formula) and with the structural formula:

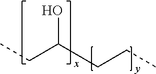

Polyvinyl alcohol (PVOH): is a polymer which can be produced by complete saponification (hydrolysis) of polyvinyl acetate (PVAC), with the repeating unit [C₂H₄O] (molecular formula) and with the structural formula:

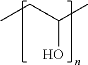

Adhesion promoter (HV): can be provided as intermediate layers in the film according to the present disclosure and stand for adhesive layers which ensure good composite adhesion of the individual layers to one another. HV can be based on a base material, selected from a group, consisting of PE, PP, ethylene-vinyl acetate copolymer (EVA), ethylene-methacrylic acid copolymer (EMA), ethylene-methyl methacrylate copolymer (EMMA), ethylene-acrylic acid copolymers (EAA) and an ionomer, or a mixture thereof. Particularly suitable adhesion promoters according to the present disclosureare ethylene-vinyl acetate copolymer (EVA), ethylene-methacrylic acid copolymer (EMA) or ethylene-methyl methacrylate copolymer (EMMA), each with a purity of >99%, preferably >99.9%. Unless defined above, the person skilled in the art understands the abbreviations used to mean conventional definitions commonly used in the technical field of the present disclosure.

For the purposes of the present disclosure, the designation of a material as a “layer component” means that a layer of the film according to the present disclosure at least partially comprises this material. For the purposes of the present disclosure, the term “layer component” may include, in particular, that the layer consists entirely or exclusively of this material.

For the purposes of the present disclosure, “inner layer” means a layer of the film which, if the film according to the present disclosure is used as packaging material as intended or as a part thereof, is a surface of the film facing or coming into contact with a good to be packaged. Consequently, the inner layer is the interface of the film to the goods to be packaged when the film is used as a packaging material or represents the interface of the film to a further layer or a layer package if a further layer or a layer package is to be laminated onto the film according to the present disclosure in the course of further processing.

For the purposes of the present disclosure, “outer layer” means a layer of the film which forms a surface of the film to the outside and which, when the film according to the present disclosure is used as a packaging material or as a part thereof in accordance with its intended use, does not come into direct contact with the goods to be packaged. The outer layer is therefore the interface between the film and the external environment. The outer layer and the inner layer are the two layers that seal the film to the outside and are virtually opposite each other.

For the purposes of the present disclosure, “middle” or “intermediate” layer means a layer of the film which is arranged between the outer layer and the inner layer of the film.

All mass fractions (in %), temperatures (in ° C.) and durations (in seconds) disclosed in the context of the present application are deemed to be specified and determined to one decimal place (e.g. “50%” means “50.0%”; “120° C.” means “120.0° C.”; “2 seconds means 2.0 seconds”; “1.5 seconds” means “1.5 seconds”), if not specified more precisely (e.g. “0.05 seconds” means “0.05 seconds”).

### DETAILED DESCRIPTION

The above-mentioned object is solved by the subject-matter defined in the claims and/or disclosed below.

The method according to the present disclosure can be carried out or produced using a plurality of process techniques known to the person skilled in the art. These include, in particular, the so-called triple-bubble process, the double-bubble process with downstream thermofixing or heat-setting and the tenter-frame process with simultaneous, biaxial stretching. In the thermofixing process, the films are passed through an oven and treated with temperature, in most cases, as with the tenter-frame process, using hot air. Alternatively, in the triple-bubble process, the film is thermofixed using infrared or hot water vapor to reduce the shrinkage caused by stretching. Alternatively, in the double-bubble process, the downstream thermofixing can be carried out using tempering rollers or a horizontal hot-air oven. Accordingly, the film according to the present disclosure can be produced using these process techniques or other suitable process techniques known to the person skilled in the art. Such process techniques are known to the skilled person from the relevant literature, for example the textbook Savic, Z., Savic, I.: “Sausage Casings”, publisher: VICTUS Lebensmittelindustriebedarf Vertriebsgesellschaft m.b.H., Vienna, 1st edition, June 2002, chapter 7, in particular subchapter 4.2, pages 244 to 301, or from his practical work.

In particular, the method according to the present disclosure and the film according to the present disclosure can preferably be carried out or produced using the double-bubble and in particular the triple-bubble process, for which the applicant provides suitable equipment. The film can be coextruded from the respective resin melts, preferably with thermal separation of the individual layers, for example by a nozzle blowing head or die blowing head of the applicant set up for the production of single-layered or composite films with two, three or more layers, coextruded with a water cooling system of the applicant, reheated, simultaneously stretched biaxially (in the machine direction (MD) and in the transverse direction (TD)) by an enclosed compressed air bubble and finally, in a further step, thermofixed in a defined temperature regime and optionally relaxed. The relaxation can take place in both directions, i.e. both in the machine direction (MD) and in the transverse direction (TD). It is desirable for the method according to the present disclosure that the relaxation, if used, does not take place equally in both directions (MD and TD), but that the relaxation factor in the transverse direction TD is always greater than the relaxation factor in the machine direction MD. In addition, relaxation is also possible in only one direction, i.e. only in TD.

The relaxation direction can always be selected independently of each other. The quantitative expression of the relaxation is expressed in the context of the present disclosure by the so-called relaxation factor, as defined in more detail below.

Another way of producing the film according to the present disclosure is by stretching a (co-) extruded flat film according to the tenter-frame process known to the person skilled in the art.

The film of the present disclosure can be advantageously obtained on a device or system of the applicant for the production of tubular food films for food packaging, such as shrink films or shrink bags, using the nozzle blowing process, if the device disclosed in patent specification DE 199 16 428 B4 of the same applicant is also used for the rapid cooling of thin thermoplastic tubes after extrusion. For this purpose, a corresponding further development according to patent specification DE 100 48 178 B4 can also be considered.

Here, the tubular film produced from the plastic melt in the nozzle blowing head is subjected to intensive cooling, during which the amorphous structure of the thermoplastics from the plastic melt is retained. The tubular film extruded vertically from the plastic melt in the nozzle blowing head initially moves into the cooling device for cooling without touching the wall, as described in detail in the publications DE 199 16 428 B4 and DE 100 48 178 B4. In order to avoid repetition, full reference is made to the contents of documents DE 199 16 428 B4 and DE 100 48 178 B4 with regard to details of the methods, design and operation of this cooling device, also known as the calibrating device.

The tubular film then passes through supports in the cooling device, against which the film is supported as a result of a differential pressure between the interior of the tubular film and the coolant, whereby a liquid film is maintained between the film and the supports, so that sticking of the tubular film is excluded. The diameter of the supports influences the diameter of the tubular film, which is why this cooling device from the same applicant is also referred to as a calibrating device.

The method according to the present disclosure makes it possible for the first time to produce a single- or multi-layered film based on high-density polyethylene (HDPE) that meets the high requirements for a food packaging material. According to the present disclosure, it is desirable that the film is based on HDPE. The film according to the present disclosure contains the HDPE (hereinafter referred to as “first polyethylene PE1” and composed as defined above as the “first polyethylene PE1”). In the context of the present disclosure, the first polyethylene PEI has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³. In the film according to the present disclosure, the mass fraction of the first polyethylene PE1 is greater than 30% to 100%, based on the total mass of the film.

The film produced has little to no shrinkage (0 to 3%, preferably 0 to 2%, in particular 0 to 1%, shrinkage in each of the machine direction (MD) and the transverse direction (TD), measured at 90° C. according to ASTM D2732-14, as described above). The inventor has surprisingly found that the manufacturing method according to the present disclosure can only be operated stably and the resulting film has satisfactory properties, in particular with regard to its mechanical properties, if the stretching in the machine direction is greater than the stretching in the transverse direction during simultaneous biaxial stretching. This is a unique feature of the method according to the present disclosure, since in simultaneous biaxial stretching, especially in the double-bubble and triple-bubble process, the stretching in the machine direction is conventionally always set to be smaller than the stretching in the transverse direction.

Furthermore, the inventor has surprisingly found that in the method according to the present disclosure, contrary to all expectations in the art, the following relationship applies: the greater the stretching of the film according to the present disclosure at the stretching temperature provided for in the present disclosure, the smaller the shrinkage and the smaller the haze (the greater the clarity) of the film and the stiffer the film. Therefore, in the method according to the present disclosure, it is possible to achieve a small shrinkage of the films or even to eliminate it completely by selecting high stretch factors in both directions. However, according to the present disclosure, the stretch factor must not exceed 8.0, preferably 7.5, in the machine direction and 7.0, preferably 6.5, in the transverse direction, as otherwise the stability of the stretching process and thus, of the manufacturing method of the film can no longer be ensured.

In addition, the inventor has found that the higher the density of the raw material used, the higher the strength (hardness) and stiffness of the resulting film. Furthermore, he has found that the higher the stretching (total stretching=sum of stretching in both directions; or just stretching in the machine direction), the higher the strength and stiffness of the resulting film. This is because the crystallinity of the stretched polymer and thus, the order of the molecules in the polymer increases with increasing stretching. In turn, as the order of the molecules increases, the stiffness of the resulting film increases and its shrinkage decreases. During stretching, the temperature and the duration of the stretching also play a role: the higher the temperature to which the film is exposed during stretching and the longer the stretching under temperature lasts, the more the crystallinity and thus the stiffness of the stretched polymer increases.

Furthermore, the inventor has recognized that simultaneous biaxial stretching, for example realized by the well-known double-bubble and triple-bubble process, realizes particular advantages in connection with the present disclosure: For example, polymers of the highest density can be processed, which enable very high stretch factors due to their high density. Due to the rapid cooling of the newly formed extrusion tube that is usually used, the polymer tube is largely in an amorphous state prior to stretching. Due to the simultaneous biaxial stretching, i.e. the simultaneous stretching in the machine direction as well as in the transverse direction, the polymer material is therefore in a largely amorphous state at the beginning of “each” stretching, which is why it can be stretched with a high stretch factor. In contrast, the polymer material is already semi-crystalline or even crystalline after the first stretching in monoaxial stretching via pairs of rollers or in two-stage stretching using the tenter-frame process, which is why the use of polymer materials with a high density is impossible in these process technologies and also a downstream, further stretching is no longer possible or is only possible with materials that have a comparatively low density.

According to the inventor's findings, it is therefore ideal to use a triple-bubble process with simultaneous biaxial stretching for the following reasons: Due to the rapid cooling of the newly formed polymer tube after coextrusion, the amorphous state of the polymer is largely preserved until stretching. Due to the subsequent simultaneous stretching, the polymer material is therefore largely in an amorphous state in both directions (MD and TD) at the start of stretching. Even if the triple-bubble process does not achieve quite as high stretch factors as monoaxial stretching using pairs of rollers or the tenter-frame process, the triple-bubble process is the only one that allows polymer materials of the highest density to be processed. Thus, the triple-bubble process allows high stretch factors to be achieved in both directions in polymer materials with the highest densities, ultimately resulting in very stable and stiff films of high clarity and little or no shrinkage. As the inventor has also found out, the density of the processed polymer materials is a more decisive factor than the achievable stretch factors, which is why the triple-bubble process achieves the best results overall compared to monoaxial stretching and the tenter-frame process.

A further finding of the inventor is that the longer the thermofixing (dwell time during thermofixing=duration of fixing at the fixing temperature specified according to the present disclosure) of the film in the method according to the present disclosure, the more transparent the resulting film was. It was also observed that the higher the temperature during thermofixing, the more transparent or less hazy the resulting film was.

Furthermore, during the development of the method according to the present disclosure, it was surprisingly found that the higher the temperature during thermofixation, the clearer the resulting film and the higher the stiffness and mechanical stability of the resulting film. And: The smaller the relaxation during thermofixation, the clearer the resulting film and the higher the stiffness of the resulting film. This is probably because the more extensive the stretching, the more crystalline and therefore more transparent the resulting film. This is also accompanied by a lower shrinkage of the film. If relaxation is completely dispensed within the method according to the present disclosure, the resulting film becomes even clearer in the sense of being more transparent.

Overall, the inventor of the present disclosure has recognized that an increase in stretch factors during stretching combined with a stretch factor that is greater in the machine direction than in the transverse direction and a higher temperature and lower relaxation factors (or no relaxation) during thermofixing leads to a high transparency or clarity, a high stiffness and a low shrinkage of the resulting film according to the present disclosure. He suspects that the reason for this surprising achievement of the improved properties is a higher crystallinity of the main component of the films according to the present disclosure, namely the first polyethylene PE1, compared to conventional methods or films. In the film according to the present disclosure, the residual stretch factor (RV_{TD}) in the transverse direction (TD) is preferably greater than 2.8 and less than 4.4, further preferably greater than 3.6 and less than 4.4, in particular greater than 4.1 and less than 4.4. Furthermore, the residual stretch factor (RV_{MD}) of the film in the machine direction (MD) is preferably greater than 3.6 and less than 5.4, more preferably greater than 4.1 and less than 5.4, in particular greater than 5.0 and less than 5.4. The above ranges for the RV_{TD} and the RV_{MD} are particularly suitable if the film according to the present disclosure contains a first polyethylene PE1 having a density of greater than 0.960 g/cm³. In the film according to the present disclosure, which contains a first polyethylene PE1 with a density of greater than 0.940 g/cm³ and less than or equal to 0.960 g/cm³, the residual stretch factor (RV_{TD}) of the film in the transverse direction (TD) is preferably greater than 4.0 and less than 6.0, more preferably greater than 4.5 and less than 6.0, in particular greater than 5.0 and less than 6.0. Furthermore, the residual stretch factor (RV_{MD}) of the film containing a first polyethylene PE1 with a density of greater than 0.940 g/cm³ and less than or equal to 0.960 g/cm³ is preferably greater than 5.0 and less than 7.0 in the machine direction (MD), further preferably greater than 5.5 and less than 7.0, in particular greater than 6.0 and less than 7.0. In any case, however, in the film according to the present disclosure, the residual stretch factor (RV_{MD}) of the film in the machine direction (MD) is preferably greater than the residual stretch factor (RV_{TD}) in the transverse direction (TD).

Furthermore, the inventor has surprisingly found the following correlations in connection with the method according to the present disclosure and the film according to the present disclosure:
The greater the respective stretch factor or degree of stretching in simultaneous biaxial stretching, the lower the shrinkage of the resulting film.
The greater the respective stretch factor or degree of stretching in simultaneous biaxial stretching, the lower the haze or turbidity and the higher the clarity or transparency of the resulting film.
The greater the respective stretch factor or degree of stretching in simultaneous biaxial stretching, the greater the stiffness of the resulting film.
The higher the temperature at which the film is thermofixed, the higher the clarity or transparency and the stability of the resulting film.
The longer the duration of the thermofixing of the film, the higher the clarity or transparency and the stability of the resulting film.
The smaller the relaxation factor during thermofixation, the higher the clarity or transparency of the resulting film.
The smaller the relaxation factor during thermofixation, the higher the stiffness of the resulting film.

The method according to the present disclosure can completely omit a step of laminating or extrusion coating the film or individual layers or layer packages. On the one hand, this saves an additional method step, which simplifies the method according to the present disclosure in terms of its implementation and the equipment required. On the other hand, the resulting film is mechanically more stable, since the lamination interfaces of a laminated film always represent a mechanical weak point and increase the risk of delamination of one or more layers of the film. Since the film according to the present disclosure is extruded or coextruded in a single step, the resulting film can be up to 50% thinner in contrast to films which are produced by separate extrusion of layers and subsequent lamination of the separately extruded layers and have thicknesses of, for example, 40 to 60 μm. This is also due to the fact that the method according to the present disclosure allows HDPE (=PE1) to be used as a layer component with a high density for the production of the film according to the present disclosure. In any case, the up to 50% thinner film according to the present disclosure with a thickness of, for example, 20 to 30 μm results in a corresponding material saving and thus, also energy saving compared to a comparable film produced by lamination with an analogous layer structure.

However, it is not excluded that the film according to the present disclosure is laminated in a separate step with one or more other layers to form a ready-to-use film.

Another aspect of the method according to the present disclosure is that the film is cooled very quickly to a temperature of 20° C. or below after extruding. As a result, thermal energy is removed from the film practically immediately after its formation by extrusion or coextrusion, thereby preventing crystallization of the polymer molecules or at least preventing crystallization from progressing. Accordingly, it is also important to heat the film to the stretching temperature within a few seconds before stretching and preferably to carry out stretching immediately after reaching the stretching temperature, i.e., preferably without any time delay. Furthermore, it is advantageous in this context, but not absolutely necessary, if the film is cooled to a temperature below 50° C. as quickly as possible after stretching.

By limiting the time during which the film is exposed to high temperatures, for example before or during stretching, as provided for in the present disclosure, crystallization of the HDPE (=PE1) is prevented as far as possible. Technically, this is ensured by the extremely short heating and cooling times and by minimizing the phases during which the film is exposed to high temperatures, for example the phase from reaching the stretching temperature and the start of stretching. Thus, before stretching, the film according to the present disclosure must be heated from the temperature to which it was cooled after extruding to the stretching temperature within a time period of 1 to 18 seconds, preferably 1.5 to 12 seconds, in particular 2 to 9 seconds. In other words, at the usual running speeds (transport speeds) of the film, heating must take place over a distance of between about 5 and 50 cm. According to the current state of development, such heating cannot be technically realized within a time period of less than 1 second. On the other hand, if heating takes too long, in particular longer than 18 seconds, there is a risk that crystallization of the polyolefin material will begin or progress too far. The aim of exposing the film to a high temperature and thus to a thermal load with the risk of crystallization progressing for a time as short as possible is also served by the measure of cooling the film immediately after extruding, as provided for in the method according to the present disclosure.

In the method according to the present disclosure, it is fundamentally important that the film does not crystallize or does not crystallize too extensively before stretching. If, on the other hand, the film crystallizes after stretching, this is basically unproblematic or even desirable, as it is advantageous. At most, there is a risk that the bubble trapped by the film during stretching will cause the film to burst and thus lead to an unstable process (this applies in particular to the triple-bubble process and the double-bubble process).

In order to avoid crystallization of the polyolefin material of the film, the method according to the present disclosure can therefore also provide for the film to be cooled very quickly to a temperature of below 50° C. after stretching and before thermofixation. Depending on the process technology used, this cooling step may be mandatory, such as in the triple-bubble process or the double-bubble process, or optional, such as in the tenter-frame process. For example, the inventor has found that when manufacturing the film according to the present disclosure using the triple-bubble process, cooling the film after stretching to below 50° C., preferably below 40° C., even better below 30° C., is desirable, as otherwise the manufacturing method is unstable.

Furthermore, compliance with the temperature ranges provided for thermofixing according to the present disclosure is desirable. For example, the inventor has found that when the film is thermofixed at a temperature of less than 60° C., measured at the surface of the film, and depending on the polymer material used, already at less than 100° C., the film becomes too turbid and thus, unusable for most intended uses, especially as a food film. If, on the other hand, the temperature of the film is above 200° C. during thermofixing, the film is thermally damaged and may, for example, burst. In contrast, the temperature windows provided according to the present disclosure, in particular the windows greater than 60° C. and less than 200° C., preferably greater than 80° C. and less than 180° C. and in particular greater than 100° C. and less than 160° C., provide very transparent films with good stability. These temperature windows apply in particular if the first polyethylene PE1 contained in the film according to the present disclosure has a density of greater than 0.960 g/cm³. The same temperature windows preferably also apply if the film according to the present disclosure contains the first polypropylene PP 1 in the outer layer or the outer layer consists of the first polypropylene PP 1.

If, on the other hand, the first polyethylene PE1 contained in the film according to the present disclosure has a density of greater than 0.950 g/cm³ and less than 0.960 g/cm³, the temperature of the film, measured at the surface of the film, is preferably greater than 80° C. and less than 180° C. during thermofixing. If, on the other hand, the first polyethylene PE1 contained in the film according to the present disclosure has a density of greater than 0.940 g/cm³ and less than 0.950 g/cm³, the temperature of the film, measured at the surface of the film, is preferably greater than 60° C. and less than 160° C. during thermofixing.

The particular advantage of the film according to the present disclosure is that it is recyclable. The film according to the present disclosure is preferably flat or tubular.

In the film according to the present disclosure, EVOH can serve as a layer component for a good barrier for oxygen and other gases. Additionally or instead, PVOH may also be provided as a layer component in the film according to the present disclosure within the scope of the present disclosure. According to the inventor's knowledge, PVOH is thermally more sensitive and can therefore only be processed up to a temperature of about 190° C. and is also more expensive. However, PVOH offers an even better gas barrier than EVOH. In addition, PVOH is easy to process together with polyethylene or polypropylene and can therefore also be combined very well with the PE and PP materials processed in this application.

According to the present disclosure, it is preferred that the inner layer of the film according to the present disclosure is a polyolefinic sealing layer which preferably comprises or consists of a polyethylene PE, in particular the second polyethylene PE2 or the third polyethylene PE3.

According to the present disclosure, it is preferred that one or more intermediate layers of the film according to the present disclosure comprise or consist of a polyolefinic polymer, preferably a polyethylene PE, in particular the third polyethylene PE3.

Alternatively, it may be provided according to the present disclosure that the film according to the present disclosure has an outer layer consisting of the first polypropylene PP1 and an inner layer consisting of the first polyethylene PE1, the second polyethylene PE2 or the third polyethylene PE3. This constellation improves the heat resistance of the film compared to a film consisting only of PE, for example. This is because the first polypropylene PP1 has a higher melting temperature compared to PE (approx. 160 to 165° C. for PP1 vs. 130 to 135° C. for PE) and this improves the heat resistance of the entire film while maintaining the good sealing properties of the PE inner layer. In addition, this constellation increases the difference in melting temperatures between the outer layer and the inner layer compared to a film in which the outer layer and the inner layer each consist of a polyethylene. This improves the processability of the overall film at higher temperatures, which means that higher cycle rates can be achieved in the production method of the film.

According to the present disclosure, it can be provided that the film according to the present disclosure has a middle layer consisting of the third polypropylene PP3. The provision of a middle layer consisting of the third polypropylene PP3 advantageously further improves the stability of the manufacturing process (process stability) of the film and achieves maximum stability during manufacture.

### Preferred Embodiments of the Film According to the Present Disclosure

Some exemplary embodiments of the film according to the present disclosure are listed schematically below. These embodiments are suitable either for immediate use (“ready to use” or RTU) or for laminating on further layers. If only one material is specified for a layer, this means that the layer consists of the specified material. The respective layer structure is shown as follows (layer sequence from left to right in the line means from outer layer to inner layer):
Single-layered film made of: PE1
Single-layered film made of: >65 mass % PE1+<35 mass % PE2 or PE3; e.g. 75 mass % PE1+25 mass % PE2; or 70 mass % PE1+20 mass % PE2+10 mass % PE3
2-layered film: PE1//PE1
2-layered film: PE1//PE2
2-layered film: PE3//PE1
3-layered film: PE1//PE1//PE1
3-layered film: PE2//PE1//PE2
3-layered film: PE3//PE1//PE1//PE1
3-layered film: PE3//PE1//PE2
3-layered film: PE3//PE1//PE3
3-layered film: PP1//HV//PE1
4-layered film: PE2//PE1//PE1//PE2
4-layered film: PE3//PE1//PE1//PE2
4-layered film: PE3//PE1//PE3//PE2
4-layered film: PE3//PE1//PE1//PE3
4-layered film: PP1//HV//PE1//PE2
4-layered film: PP1//HV//PE1//PE3
5-layered film: PE3//PE1//PE1//PE1//PE2
5-layered film: PE3//PE1//PE1//PE1//PE3
5-layered film: PE3//PE1//PE1//PE3//PE2
5-layered film: PE1//HV//EVOH//HV//PE1
5-layered film: PP1//HV//EVOH//HV//PE1
5-layered film: PE1//HV//EVOH//HV//PE2
5-layered film: PE1//HV//EVOH//HV//PE3
5-layered film: PE3//HV//EVOH//HV//PE1
5-layered film: PE1//HV//PVOH//HV//PE1
5-layered film: PP1//HV//PVOH//HV//PE1
5-layered film: PE1//HV//PVOH//HV//PE2
5-layered film: PE1//HV//PVOH//HV//PE3
5-layered film: PE3//HV//PVOH//HV//PE1
5-layered film: PP1//PP3//HV//PE1//PE2
5-layered film: PP1//PP3//HV//PE1//PE3
6-layered film: PE1//HV//EVOH//HV//PE1//PE2
6-layered film: PP1//HV//EVOH//HV//PE1//PE2
6-layered film: PE3//PE1//HV//EVOH//HV//PE2
6-layered film: PE3//PE1//HV//EVOH//HV//PE3
6-layered film: PE2//PE1//HV//EVOH//HV//PE2
6-layered film: PE1//HV//PVOH//HV//PE1//PE2
6-layered film: PP1//HV//PVOH//HV//PE1//PE2
6-layered film: PE3//PE1//HV//PVOH//HV//PE2
6-layered film: PE3//PE1//HV//PVOH//HV//PE3
6-layered film: PE2//PE1//HV//PVOH//HV//PE2
6-layered film: PP1//PP3//HV//EVOH//HV//PE1
6-layered film: PP1//PP3//HV//PVOH//HV//PE1
7-layered film: PE2//PE1//HV//EVOH//HV//PE1//PE2
7-layered film: PE3//PE1//HV//EVOH//HV//PE1//PE2
7-layered film: PE3//PE1//HV//EVOH//HV//PE1//PE3
7-layered film: PE2//PE1//HV//PVOH//HV//PE1//PE2
7-layered film: PE3//PE1//HV//PVOH//HV//PE1//PE2
7-layered film: PE3//PE1//HV//PVOH//HV//PE1//PE3
7-layered film: PP1//HV//PE1//HV//EVOH//HV//PE1
7-layered film: PP1//HV//PE1//HV//PVOH//HV//PE1
8-layered film: PE3//PE1//HV//EVOH//HV//PE1//PE3//PE2
8-layered film: PE3//PE1//HV//PVOH//HV//PE1//PE3//PE2
8-layered film: PP1//HV//PE1//HV//EVOH//HV//PE1//PE2
8-layered film: PP1//HV//PE1//HV//PVOH//HV//PE1//PE2
9-layered film: PE2//PE3//PE1//HV//EVOH//HV//PE1//PE3//PE2
9-layered film: PE2//PE3//PE1//HV//PVOH//HV//PE1//PE3//PE2
9-layered film: PP1//PP3//HV//PE1//HV//EVOH//HV//PE1//PE2
9-layered film: PP1//PP3//HV//PE1//HV//PVOH//HV//PE1//PE2

### Explanations and Abbreviations Referring to the Preferred Embodiments Described Above

“//” symbolizes the layer boundary; for example, “A//B//C” means: a multi-layered film with a total of three layers, of which the outer layer consists of component A, the middle layer (=intermediate layer) consists of component B, and the inner layer consists of component C;
identical reference signs correspond to the identical polymer components as in the claims;
all the embodiments shown can be produced by means of the method according to the present disclosure using triple-bubble technology;
all the embodiments of the film according to the present disclosure shown have at least the limitations of at least one of the product claims; in particular, all the embodiments are extruded, simultaneously biaxially stretched and thermofixed films;
PE1=first polyethylene (PE1) (=HDPE) as defined above;
PE2=second polyethylene (PE2) as defined above, sealable;
PE3=third polyethylene (PE3) as defined above;
PP1=first polypropylene (PP1) as defined above;
PP2=second polypropylene (PP2) as defined above, sealable;
PP3=third polypropylene (PP3) as defined above;
PM2=second polymer (PM2) as defined above, preferably second polyolefin (PO2) as defined above, sealable;
PM3=third polymer (PM3) as defined above, preferably third polyolefin (PO3) as defined above;
EVOH=ethylene vinyl alcohol copolymer (EVOH) as defined above;
PVOH=polyvinyl alcohol (PVOH) as defined above; and
HV=adhesion promoter (HV) as defined above.

In the following, preferred embodiments of the method according to the present disclosure are listed:

### Embodiment 1 (V1)

(V1) A method for producing a single- or multi-layered film, the method comprising at least the following steps:
   a step of extruding one layer or co-extruding several layers, whereby an extruded film is obtained;
   a step of simultaneous biaxial stretching of the extruded film; and
   a step of thermofixing the stretched film;
   wherein the film contains a first polyethylene (PE1) in a mass fraction of greater than 50%, preferably greater than 65%, preferably greater than 80%, particularly preferably greater than 90%, relative to the total mass of the film;
   wherein the first polyethylene (PE1) has a density of greater than 0.950 g/cm³, particularly preferably greater than 0.960 g/cm³, and less than or equal to 1.010 g/cm³, preferably less than 1.000 g/cm³, particularly preferably less than 0.970 g/cm³, measured according to DIN EN ISO 1183-1:2019-09;
   wherein the film does not contain any of the following polymers, selected from the group, consisting of polyethylene terephthalate (PET), polyvinylidene chloride (PVDC) and polyamide (PA);
   wherein the film is cooled to a first temperature (T1) of below 20° C., particularly preferably below 15° C., within a time period of from 0.05 to 0.5 seconds, particularly preferably from 0.07 to 0.3 seconds, after extruding;
   wherein a stretch factor (V_{MD}) in the machine direction or longitudinal direction (MD) is greater than 5.0, preferably greater than 6.0, particularly preferably greater than 7.0, and less than 8.0;
   wherein a stretch factor (V_{TD}) in the transverse direction or transverse direction (TD) is greater than 4.0, preferably greater than 5.0, particularly preferably greater than 6.0, and less than 7.0;
   wherein the stretch factor (V_{MD}) in the machine direction (MD) is greater than the stretch factor (V_{TD}) in the transverse direction (TD);
   wherein the film has a second temperature (T2) of greater than 130° C. and less than 170° C., particularly preferably greater than 140° C. and less than 160° C., during stretching;
   wherein the film is heated from the first temperature (T1) to the second temperature (T2) within a time period of 1.0 to 12 seconds, particularly preferably 2 to 9 seconds, before stretching;
   wherein a time period (Δt) (=t2−t1) between a first time point (T1) at which the film reaches the second temperature (T2) and a second time point (T2) at which the stretching of the film begins is 0.1 to 3 seconds, particularly preferably 0.3 to 1.5 seconds;
   wherein the film has a third temperature (T3) of greater than 80° C. and less than 180° C., particularly preferably greater than 100° C. and less than 160° C., during the thermofixing process; and
   wherein a dwell time during the thermofixing (=duration of the thermofixing of the film), during which the film has the third temperature (T3), is greater than 1 second and less than 45 seconds, particularly preferably greater than 3 seconds and less than 30 seconds.

### Embodiment 2 (V2)

(V2) The method according to (V1), wherein the method further comprises relaxing the film during the thermofixing of the film;
   wherein a relaxation factor (R_{MD}) in the machine direction (MD) is greater than 0.00 and less than 0.10, preferably greater than 0.00 and less than 0.05, particularly preferably greater than 0.00 and less than 0.03;
   wherein a relaxation factor (R_{TD}) in the transverse direction (TD) is greater than 0.00 and less than 0.20, preferably greater than 0.00 and less than 0.10, particularly preferably greater than 0.00 and less than 0.05; and wherein the relaxation factor (R_{TD}) in the transverse direction (TD) is greater than the relaxation factor (R_{MD}) in the machine direction (MD);
   wherein the film has the third temperature (T3) during relaxation; and
   wherein a duration of the relaxation of the film during which the film has the third temperature (T3) is preferably greater than 5 seconds, more preferably greater than 10 seconds, and less than 30 seconds.

### Embodiment 3 (V3)

(V3) The method according to (V1) or (V2), wherein the method further comprises cooling the film after stretching and before thermofixation;
   wherein the film is cooled to a fourth temperature (T4) of below 40° C., particularly preferably below 30° C., within a time period of from 0.01 to 0.5 seconds, particularly preferably from 0.07 to 0.3 seconds, after stretching.

### Embodiment 4 (V4)

(V4) The method according to (V1), (V2) or (V3), wherein the film further comprises a first polypropylene (PP1); and wherein the first polypropylene (PP1) has a heat deflection temperature of greater than 85° C., particularly preferably greater than 95° C., measured according to ASTM D648-18.

### Embodiment 5 (V5)

(V5) The method according to (V1), (V2), (V3) or (V4), wherein the film is multi-layered;
   wherein the film contains ethylene-vinyl alcohol copolymer (EVOH) in a mass fraction of less than 5%, based on the total mass of the film;
   wherein the film comprises at least one layer consisting of ethylene-vinyl alcohol copolymer (EVOH).

### Embodiment 6 (V6)

(V6) The method according to (V1), (V2), (V3), (V4) or (V5), wherein the film is multi-layered;
   wherein the film contains polyvinyl alcohol (PVOH) in a mass fraction of less than 5%, based on the total mass of the film;
   wherein the film comprises at least one layer consisting of polyvinyl alcohol (PVOH).

### Embodiment 7 (V7)

(V7) The method according to (V1), (V2), (V3), (V4), (V5) or (V6), wherein the film is multi-layered;
   wherein the film comprises an outer layer consisting of a second polyethylene (PE2);
   wherein the second polyethylene (PE2) has a density of less than 0.92 g/cm³ and greater than 0.87 g/cm³, measured according to DIN EN ISO 1183-1:2019-09; and
   wherein the outer layer contains no ethylene-vinyl alcohol copolymer (EVOH) and no polyvinyl alcohol (PVOH).

### Embodiment 8 (V8)

(V8) The method according to (V1), (V2), (V3), (V4), (V5), (V6) or (V7), wherein the film is multi-layered;
   wherein the film has an inner layer consisting of a second polyethylene (PE2);
   wherein the second polyethylene (PE2) has a density of less than 0.92 g/cm³ and greater than 0.87 g/cm³, measured according to DIN EN ISO 1183-1:2019-09; and
   wherein the inner layer contains no ethylene-vinyl alcohol copolymer (EVOH) and no polyvinyl alcohol (PVOH).

### Embodiment 9 (V9)

(V9) The method according to (V1), (V2), (V3), (V4), (V5), (V6), (V7) or (V8), wherein the film is multi-layered;
   wherein the film comprises at least one layer comprising or consisting of the first polyethylene (PE1);
   wherein the film comprises at least one layer containing or consisting of ethylene-vinyl alcohol copolymer (EVOH);
   wherein the film comprises at least one layer containing or consisting of a second polyethylene (PE2); and
   wherein the second polyethylene (PE2) is a polyethylene (PE) having a density of less than 0.92 g/cm³ and greater than 0.87 g/cm³, measured according to DIN EN ISO 1183-1:2019-09.

### Embodiment 10 (V10)

(V10) The method according to (V1), (V2), (V3), (V4), (V5), (V6), (V7), (V8) or (V9), wherein the film is multi-layered;
   wherein the film comprises at least one layer comprising or consisting of the first polyethylene (PE1);
   wherein the film comprises at least one layer containing or consisting of polyvinyl alcohol (PVOH);
   wherein the film comprises at least one layer containing or consisting of a second polyethylene (PE2); and
   wherein the second polyethylene (PE2) is a polyethylene (PE) having a density of less than 0.92 g/cm³ and greater than 0.87 g/cm³, measured according to DIN EN ISO 1183-1:2019-09.

### Embodiment 11 (V11)

(V11) The method according to (V1), (V2), (V3), (V4), (V5), (V6), (V7), (V8), (V9) or (V10), wherein the film is multi-layered;
   wherein the film comprises at least one layer comprising or consisting of the first polyethylene (PE1);
   wherein the film comprises at least one layer containing or consisting of ethylene-vinyl alcohol copolymer (EVOH);
   wherein the film comprises at least one layer containing or consisting of a second polyethylene (PE2);
   wherein the film comprises at least one layer containing or consisting of a third polyethylene (PE3) and/or a third polypropylene (PP3);
   wherein the second polyethylene (PE2) is a polyethylene (PE) with a density of less than 0.92 g/cm³ and greater than 0.87 g/cm³, measured according to DIN EN ISO 1183-1:2019-09;
   wherein the third polyethylene (PE3) has a density which is less than the density of the first polyethylene (PE1) and greater than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).

### Embodiment 12 (V12)

(V12) The method according to (V1), (V2), (V3), (V4), (V5), (V6), (V7), (V8), (V9), (V10) or (V11), wherein the film is multi-layered;
wherein the film comprises at least one layer comprising or consisting of the first polyethylene (PE1);
wherein the film comprises at least one layer containing or consisting of polyvinyl alcohol (PVOH); and
wherein the film comprises at least one layer containing or consisting of a second polyethylene (PE2);
wherein the film comprises at least one layer containing or consisting of a third polyethylene (PE3) and/or a third polypropylene (PP3);
wherein the second polyethylene (PE2) is a polyethylene (PE) with a density of less than 0.92 g/cm³ and greater than 0.87 g/cm³, measured according to DIN EN ISO 1183-1:2019-09;
wherein the third polyethylene (PE3) has a density which is less than the density of the first polyethylene (PE1) and greater than the density of the second polyethylene (PE2); and
wherein the third polypropylene (PP3) has a heat deflection temperature which is lower than the heat deflection temperature of the first polypropylene (PP1) and higher than the heat deflection temperature of the second polypropylene (PP2).

### Embodiment 13 (V13)

(V13) The method according to (V1), (V2), (V3), (V4), (V5), (V6), (V7), (V8), (V9), (V10), (V11) or (V12), wherein the film is multi-layered;
wherein the film comprises at least one layer comprising or consisting of the first polyethylene (PE1);
wherein the film comprises at least one layer containing or consisting of a third polyethylene (PE3) and/or a third polypropylene (PP3);
wherein the third polyethylene (PE3) has a density which is less than the density of the first polyethylene (PE1) and greater than the density of the second polyethylene (PE2); and
wherein the third polypropylene (PP3) has a heat deflection temperature which is lower than the heat deflection temperature of the first polypropylene (PP1) and higher than the heat deflection temperature of the second polypropylene (PP2).

### Embodiment 14 (V14)

(V14) The method according to (V1), (V2), (V3), (V4), (V5), (V6), (V7), (V8), (V9), (V10), (V11), (V12) or (V13), wherein the film is multi-layered;
   wherein the film comprises at least one layer comprising or consisting of the first polyethylene (PE1);
   wherein the film comprises at least one layer containing or consisting of a third polyethylene (PE3) and/or a third polypropylene (PP3), wherein the third polyethylene (PE3) has a density which is lower than the density of the first polyethylene (PE1) and higher than the density of the second polyethylene (PE2);
   wherein the third polypropylene (PP3) has a heat deflection temperature which is lower than the heat deflection temperature of the first polypropylene (PP1) and higher than the heat deflection temperature of the second polypropylene (PP2); and
   wherein the film preferably comprises at least one layer comprising or consisting of ethylene-vinyl alcohol copolymer (EVOH) and/or polyvinyl alcohol (PVOH).

### Embodiment 15 (V15)

(V15) The method according to (V1), (V2), (V3), (V4), (V5), (V6), (V7), (V8), (V9), (V10), (V11), (V12), (V13) or (V14), wherein the film is multi-layered;
   wherein the film comprises at least one layer comprising or consisting of the first polyethylene (PE1);
   wherein the film comprises at least one layer containing or consisting of a second polyethylene (PE2) having a density of less than 0.92 g/cm³ and greater than 0.87 g/cm³, measured according to DIN EN ISO 1183-1:2019-09;
   wherein the film has at least one layer which contains or consists of a third polyethylene (PE3) and/or a third polypropylene (PP3), wherein the third polyethylene (PE3) has a density which is less than the density of the first polyethylene (PE1) and greater than the density of the second polyethylene (PE2);
   wherein the third polypropylene (PP3) has a heat deflection temperature which is lower than the heat deflection temperature of the first polypropylene (PP1) and higher than the heat deflection temperature of the second polypropylene (PP2); and wherein the film preferably comprises at least one layer comprising or consisting of ethylene-vinyl alcohol copolymer (EVOH) and/or polyvinyl alcohol (PVOH).

### Embodiment 16 (V16)

(V16) The method according to (V1), (V2), (V3), (V4), (V5), (V6), (V7), (V8), (V9), (V10), (V11), (V12), (V13), (V14) or (V15), wherein the film is multi-layered;
   wherein the film comprises at least one layer comprising or consisting of the first polyethylene (PE1);
   wherein the film has at least one layer containing or consisting of a second polyethylene (PE2);
   wherein the film comprises at least one layer containing or consisting of a third polyethylene (PE3) and/or a third polypropylene (PP3);
   wherein the film does not contain ethylene-vinyl alcohol copolymer (EVOH) or polyvinyl alcohol (PVOH);
   wherein the second polyethylene (PE2) is a polyethylene (PE) with a density of less than 0.92 g/cm³ and greater than 0.87 g/cm³, measured according to DIN EN ISO 1183-1:2019-09;
   wherein the third polyethylene (PE3) has a density which is less than the density of the first polyethylene (PE1) and greater than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).

### Embodiment 17 (V17)

(V17) The method according to (V1), (V2), (V3), (V4), (V5), (V6), (V7), (V8), (V9), (V10), (V11), (V12), (V13), (V14), (V15) or (V16), wherein the film is multi-layered;
   wherein the film comprises at least one layer comprising or consisting of the first polypropylene (PP1);
   wherein the film comprises at least one layer containing or consisting of a second polyethylene (PE2);
   wherein the film comprises at least one layer containing or consisting of a third polyethylene (PE3) and/or a third polypropylene (PP3);
   wherein the film does not contain ethylene-vinyl alcohol copolymer (EVOH) or polyvinyl alcohol (PVOH);
   wherein the second polyethylene (PE2) is a polyethylene (PE) with a density of less than 0.92 g/cm³ and greater than 0.87 g/cm³, measured according to DIN EN ISO 1183-1:2019-09;
   wherein the third polyethylene (PE3) has a density which is less than the density of the first polyethylene (PE1) and greater than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).

### Embodiment 18 (V18)

(V18) The method according to (V1), (V2), (V3), (V4), (V5), (V6), (V7), (V8), (V9), (V10), (V11), (V12), (V13), (V14), (V15), (V16) or (V17), wherein the method does not comprise a step of laminating or extrusion coating the film or components thereof, particularly preferably layers of the film; and/or
   wherein the film is multi-layered and the co-extruding of the multi-layered film is performed in a single step.

In the following, preferred embodiments of the film according to the present disclosure are listed, which are preferably produced using the method according to the present disclosure, in particular using one of the above methods VI to V18:

### Embodiment 1 (F1)

(F1) Single- or multi-layered, extruded, simultaneously biaxially stretched and thermofixed film, preferably produced by the method according to the present disclosure or by a method according to one of embodiments (V1) to (V18), wherein the film comprises a first polyethylene (PE1);
   wherein the first polyethylene (PE1) has a density of greater than 0.950 g/cm³, particularly preferably greater than 0.960 g/cm³, and less than or equal to 1.010 g/cm³, preferably less than 1.000 g/cm³, particularly preferably less than 0.970 g/cm³, measured according to DIN EN ISO 1183-1:2019-09;
   wherein the film contains the first polyethylene (PE1) in a mass fraction of greater than 50%, preferably greater than 65%, preferably greater than 80%, particularly preferably greater than 90%, relative to the total mass of the film; and
   wherein the film does not contain any of the following polymers, selected from the group, consisting of polyethylene terephthalate (PET), polyvinylidene chloride (PVDC) and polyamide (PA).

### Embodiment 2 (F2)

(F2) The film according to (F1), wherein the film is not laminated.

### Embodiment 3 (F3)

(F3) The film according to (F1) or (F2),
   wherein the film is relaxed;
   wherein a residual stretch factor (RV_{MD}) of the film in the machine direction (MD) is greater than 5.0 and less than 7.0, preferably greater than 5.5 and less than 7.0;
   wherein a residual stretch factor (RV_{TD}) of the film in the transverse direction (TD) is greater than 4.0 and less than 6.0, preferably greater than 5.0 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed;
   wherein a residual stretch factor (RV_{MD}) of the film in the machine direction (MD) is greater than 5.0 and less than 7.0, and a residual stretch factor (RV_{TD}) of the film in the transverse direction (TD) is greater than 4.0 and less than 6.0; and
   wherein the residual stretch factor (RV_{MD}) of the film in the machine direction (MD) is greater than the residual stretch factor (RV_{TD}) in the transverse direction (TD).

### Embodiment 4 (F4)

(F4) The film according to (F1), (F2) or (F3), wherein the film comprises a first polypropylene (PP1); and
   wherein the first polypropylene (PP1) has a heat deflection temperature of greater than 85° C., particularly preferably greater than 95° C., measured according to ASTM D648-18.

### Embodiment 5 (F5)

(F5) The film according to (F1), (F2), (F3) or (F4), wherein the film is multi-layered;
   wherein the film contains ethylene-vinyl alcohol copolymer (EVOH) in a mass fraction of less than 5%, based on the total mass of the film; and
   wherein the film comprises at least one layer consisting of ethylene-vinyl alcohol copolymer (EVOH).

### Embodiment 6 (F6)

(F6) The film according to (F1), (F2), (F3), (F4) or (F5), wherein the film is multi-layered;
   wherein the film contains polyvinyl alcohol (PVOH) in a mass fraction of less than 5%, based on the total mass of the film; and
   wherein the film comprises at least one layer consisting of polyvinyl alcohol (PVOH).

### Embodiment 7 (F7)

(F7) The film according to (F1), (F2), (F3), (F4), (F5) or (F6), wherein the film is multi-layered;
   wherein the film comprises an outer layer consisting of a second polyethylene (PE2);
   wherein the second polyethylene (PE2) has a density of less than 0.92 g/cm³ and greater than 0.87 g/cm³, measured according to DIN EN ISO 1183-1:2019-09; and
   wherein the outer layer contains no ethylene-vinyl alcohol copolymer (EVOH) and no polyvinyl alcohol (PVOH).

### Embodiment 8 (F8)

(F8) The film according to (F1), (F2), (F3), (F4), (F5), (F6) or (F7), wherein the film is multi-layered;
   wherein the film has an inner layer comprising or consisting of a second polyethylene (PE2);
   wherein the second polyethylene (PE2) is a polyethylene (PE) having a density of less than 0.92 g/cm³ and greater than 0.87 g/cm³, measured according to DIN EN ISO 1183-1:2019-09; and
   wherein the inner layer contains no ethylene-vinyl alcohol copolymer (EVOH) and no polyvinyl alcohol (PVOH).

### Embodiment 9 (F9)

(F9) The film according to (F1), (F2), (F3), (F4), (F5), (F6), (F7) or (F8), wherein the film is multi-layered;
   wherein the film comprises at least one layer comprising or consisting of the first polyethylene (PE1);
   wherein the film comprises at least one layer consisting of ethylene-vinyl alcohol copolymer (EVOH);
   wherein the film comprises at least one layer comprising or consisting of a second polyethylene (PE2);
   wherein the second polyethylene (PE2) is a polyethylene (PE) having a density of less than 0.92 g/cm³, and greater than 0.87 g/cm³, measured according to DIN EN ISO 1183-1:2019-09.

### Embodiment 10 (F10)

(F10) The film according to (F1), (F2), (F3), (F4), (F5), (F6), (F7), (F8) or (F9), wherein the film is multi-layered;
   wherein the film comprises at least one layer comprising or consisting of the first polyethylene (PE1);
   wherein the film comprises at least one layer consisting of polyvinyl alcohol (PVOH);
   wherein the film comprises at least one layer containing or consisting of a second polyethylene (PE2); and
   wherein the second polyethylene (PE2) is a polyethylene (PE) having a density of less than 0.92 g/cm³ and greater than 0.87 g/cm³, measured according to DIN EN ISO 1183-1:2019-09.

### Embodiment 11 (F11)

(F11) The film according to (F1), (F2), (F3), (F4), (F5), (F6), (F7), (F8), (F9) or (F10), wherein the film is multi-layered;
   wherein the film comprises at least one layer comprising or consisting of the first polyethylene (PE1);
   wherein the film comprises at least one layer containing or consisting of ethylene-vinyl alcohol copolymer (EVOH);
   wherein the film comprises at least one layer containing or consisting of a second polyethylene (PE2);
   wherein the film comprises at least one layer containing or consisting of a third polyethylene (PE3) and/or a third polypropylene (PP3);
   wherein the second polyethylene (PE2) is a polyethylene (PE) with a density of less than 0.92 g/cm³ and greater than 0.87 g/cm³, measured according to DIN EN ISO 1183-1:2019-09;
   wherein the third polyethylene (PE3) has a density which is less than the density of the first polyethylene (PE1) and greater than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).

### Embodiment 12 (F12)

(F12) The film according to (F1), (F2), (F3), (F4), (F5), (F6), (F7), (F8), (F9), (F10) or (F11), wherein the film is multi-layered;
   wherein the film comprises at least one layer comprising or consisting of the first polyethylene (PE1);
   wherein the film comprises at least one layer containing or consisting of polyvinyl alcohol (PVOH); and
   wherein the film comprises at least one layer containing or consisting of a second polyethylene (PE2);
   wherein the film comprises at least one layer containing or consisting of a third polyethylene (PE3) and/or a third polypropylene (PP3);
   wherein the second polyethylene (PE2) is a polyethylene (PE) with a density of less than 0.92 g/cm³ and greater than 0.87 g/cm³, measured according to DIN EN ISO 1183-1:2019-09;
   wherein the third polyethylene (PE3) has a density which is less than the density of the first polyethylene (PE1) and greater than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).

### Embodiment 13 (F13)

(F13) The film according to (F1), (F2), (F3), (F4), (F5), (F6), (F7), (F8), (F9), (F10), (F11) or (F12), wherein the film is multi-layered;
   wherein the film comprises at least one layer comprising or consisting of the first polyethylene (PE1);
   wherein the film comprises at least one layer containing or consisting of a third polyethylene (PE3) and/or a third polypropylene (PP3);
   wherein the third polyethylene (PE3) has a density which is less than the density of the first polyethylene (PE1) and greater than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).

### Embodiment 14 (F14)

(F14) The film according to (F1), (F2), (F3), (F4), (F5), (F6), (F7), (F8), (F9), (F10), (F11), (F12) or (F13), wherein the film is multi-layered;
   wherein the film comprises at least one layer comprising or consisting of the first polyethylene (PE1);
   wherein the film comprises at least one layer containing or consisting of a third polyethylene (PE3) and/or a third polypropylene (PP3), wherein the third polyethylene (PE3) has a density which is lower than the density of the first polyethylene (PE1) and higher than the density of the second polyethylene (PE2);
   wherein the third polypropylene (PP3) has a heat deflection temperature which is lower than the heat deflection temperature of the first polypropylene (PP1) and higher than the heat deflection temperature of the second polypropylene (PP2); and
   wherein the film comprises at least one layer comprising or consisting of ethylene-vinyl alcohol copolymer (EVOH) and/or polyvinyl alcohol (PVOH).

### Embodiment 15 (F15)

(F15) The film according to (F1), (F2), (F3), (F4), (F5), (F6), (F7), (F8), (F9), (F10), (F11), (F12), (F13) or (F14),
wherein the film is multi-layered;
wherein the film comprises at least one layer comprising or consisting of the first polyethylene (PE1);
wherein the film has at least one layer which contains or consists of a second polyethylene (PE2) with a density of less than 0.92 g/cm³ and greater than 0.87 g/cm³, measured according to DIN EN ISO 1183-1:2019-09;
wherein the film has at least one layer which contains or consists of a third polyethylene (PE3) and/or a third polypropylene (PP3), wherein the third polyethylene (PE3) has a density which is less than the density of the first polyethylene (PE1) and greater than the density of the second polyethylene (PE2);
wherein the third polypropylene (PP3) has a heat deflection temperature which is lower than the heat deflection temperature of the first polypropylene (PP1) and higher than the heat deflection temperature of the second polypropylene (PP2); and
wherein the film preferably comprises at least one layer comprising or consisting of ethylene-vinyl alcohol copolymer (EVOH) and/or polyvinyl alcohol (PVOH).

### Embodiment 16 (F16)

(F16) The film according to (F1), (F2), (F3), (F4), (F5), (F6), (F7), (F8), (F9), (F10), (F11), (F12), (F13), (F14) or (F15), wherein the film is multi-layered;
wherein the film comprises at least one layer comprising or consisting of the first polyethylene (PE1);
wherein the film has at least one layer containing or consisting of a second polyethylene (PE2);
wherein the film comprises at least one layer containing or consisting of a third polyethylene (PE3) and/or a third polypropylene (PP3);
wherein the film does not contain ethylene-vinyl alcohol copolymer (EVOH) or polyvinyl alcohol (PVOH);
wherein the second polyethylene (PE2) is a polyethylene (PE) with a density of less than 0.92 g/cm³ and greater than 0.87 g/cm³, measured according to DIN EN ISO 1183-1:2019-09;
wherein the third polyethylene (PE3) has a density which is less than the density of the first polyethylene (PE1) and greater than the density of the second polyethylene (PE2); and
wherein the third polypropylene (PP3) has a heat deflection temperature which is lower than the heat deflection temperature of the first polypropylene (PP1) and higher than the heat deflection temperature of the second polypropylene (PP2).

### Embodiment 17 (F17)

(F17) The film according to (F1), (F2), (F3), (F4), (F5), (F6), (F7), (F8), (F9), (F10), (F11), (F12), (F13), (F14), (F15) or (F16), wherein the film is multi-layered;
wherein the film comprises at least one layer comprising or consisting of the first polypropylene (PP1);
wherein the film comprises at least one layer containing or consisting of a second polyethylene (PE2);
wherein the film comprises at least one layer containing or consisting of a third polyethylene (PE3) and/or a third polypropylene (PP3);
wherein the film does not contain ethylene-vinyl alcohol copolymer (EVOH) or polyvinyl alcohol (PVOH);
wherein the second polyethylene (PE2) is a polyethylene (PE) with a density of less than 0.92 g/cm³ and greater than 0.87 g/cm³, measured according to DIN EN ISO
1183-1:2019-09;
wherein the third polyethylene (PE3) has a density which is less than the density of the first polyethylene (PE1) and greater than the density of the second polyethylene (PE2); and
wherein the third polypropylene (PP3) has a heat deflection temperature which is lower than the heat deflection temperature of the first polypropylene (PP1) and higher than the heat deflection temperature of the second polypropylene (PP2).

### Embodiment 18 (F18)

(F18) The film according to (F1), (F2) or (F3), wherein the film consists of a single layer consisting of the first polyethylene (PE1); or
wherein the film consists of several, preferably two, three, four or five, layers, each consisting of the first polyethylene (PE1).
In the following, preferred embodiments of the use according to the present disclosure are listed:

### Embodiment 1 (U1)

(U1) A use of a first polyethylene (PE1) for a single- or multi-layered, extruded, simultaneously biaxially stretched and thermofixed film, preferably for the film according to the present disclosure or a film according to one of embodiments (F1) to (F18), or for the production thereof;
wherein the film contains the first polyethylene (PE1) in a mass fraction of greater than 50%, preferably greater than 65%, preferably greater than 80%, particularly preferably greater than 90%, relative to the total mass of the film;
wherein the first polyethylene (PE1) has a density of greater than 0.950 g/cm³, particularly preferably greater than 0.960 g/cm³, and less than or equal to 1.010 g/cm³, preferably less than 1.000 g/cm³, particularly preferably less than 0.970 g/cm³, measured according to DIN EN ISO 1183-1:2019-09; and
wherein the film does not contain any of the following polymers, selected from the group, consisting of polyethylene terephthalate (PET), polyvinylidene chloride (PVDC) and polyamide (PA).

### Embodiment 2 (U2)

(U2) The use according to (U1), wherein the film further comprises a first polypropylene (PP1) having a heat deflection temperature of greater than 85° C., particularly preferably greater than 95° C., measured according to ASTM D648-18.

### Embodiment 3 (U3)

(U3) A use of a film according to one of embodiments (F1) to (F18) as a ready-to-use packaging material for food or for producing a ready-to-use packaging material for food by laminating on a further polymer layer or several further polymer layers or a package of several polymer layers.

It is explicitly part of the disclosure of the present disclosure to combine any selection of the features marked “in particular” or “particularly preferred” in the claims or in the description in the sense of an overall particularly preferred embodiment of the present disclosure.

Furthermore, it is explicitly part of the disclosure of the present disclosure to combine any selection of the features marked “preferably” in the claims or in the description in the sense of an overall preferred embodiment of the present disclosure.

It is further explicitly part of the disclosure of the present disclosure to combine any selection of the features marked “particularly preferred” in the embodiments mentioned above or below in the sense of an overall particularly preferred embodiment of the present disclosure.

Furthermore, it is explicitly part of the disclosure of the present disclosure to combine any selection of the features marked “preferably” in the embodiments mentioned above or below in the sense of an overall preferred embodiment of the present disclosure.

Further disclosure of the present disclosure

In the context of the present disclosure, the term “produced according to the method” is synonymous with “producible according to the method” and may be replaced thereby.

The subject-matter of the method may be limited by anyone of the following features or by any selection of the following features including all features:
wherein the film contains the first polyethylene (PE1) in a mass fraction of greater than 50%, preferably greater than 65%, preferably greater than 80%, in particular greater than 90%, relative to the total mass of the film;
wherein a dwell time during the thermofixing (=duration of the thermofixing of the film), during which the film has the third temperature (T3), is greater than 1.5 seconds and less than 50 seconds, preferably greater than 2 seconds and less than 40 seconds, in particular greater than 3 seconds and less than 30 seconds.
The subject-matter of the product may be further limited by the following feature:
wherein the film contains the first polyethylene (PE1) in a mass fraction of greater than 50%, preferably greater than 65%, preferably greater than 80%, in particular greater than 90%, relative to the total mass of the film.

Within the scope of the present disclosure, in particular in a second item, the feature
wherein the film is cooled to a first temperature (T1) of below 20° C., preferably below 15° C., in particular below 10° C., within a time period of from 0.01 to 1 second, preferably from 0.05 to 0.5 seconds, in particular from 0.07 to 0.3 seconds, after extruding;
can be replaced or supplemented by the feature
wherein the film is cooled after extruding at a cooling rate of 240 to 24,000° C./second, preferably 800 to 3,500° C./second.
Within the scope of the present disclosure, in particular in the second item, the feature
wherein the film is heated from the first temperature (T1) to the second temperature (T2) within a time period of 1 to 18 seconds, preferably 1.5 to 12 seconds, in particular 2 to 9 seconds, before stretching;
can be replaced or supplemented by the feature
wherein the film is heated from the first temperature (T1) to the second temperature (T2) at a heating rate of 5 to 170° C./second, preferably 10 to 85° C./second.
Within the scope of the present disclosure, in particular in a sixth item, the feature wherein the film is cooled to a fourth temperature (T4) of below 50° C., preferably below 40° C., in particular below 30° C., within a time period of from 0.01 to 1 second, preferably from 0.05 to 0.5 seconds, in particular from 0.07 to 0.3 seconds, after stretching;
can be replaced or supplemented by the feature
wherein the film is cooled after stretching at a cooling rate of 100 to 10,000° C./second to a fourth temperature (T4) of below 50° C., preferably below 40° C., in particular below 30° C.

Further disclosure of the present disclosure

In the following items 1 to 59, subject-matters are defined which belong to and are included in the present disclosure:
1. A method for producing a single- or multi-layered film, the method comprising at least the following steps:
   a step of extruding one layer or co-extruding a plurality of layers, thereby obtaining an extruded film;
   a step of simultaneous biaxial stretching of the extruded film; and
   a step of thermofixing the stretched film;
   wherein the film comprises a first polyethylene (PE1);
   wherein the first polyethylene (PE1) has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09;
   wherein the film contains the first polyethylene (PE1) in a mass fraction of greater than 30%, preferably greater than 40%, preferably greater than 50%, preferably greater than 65%, preferably greater than 80%, in particular greater than 90%, relative to the total mass of the film;
   wherein the film does not contain any of the following polymers, selected from the group, consisting of polyethylene terephthalate (PET), polyvinylidene chloride (PVDC) and polyamide (PA);
   wherein the stretch factor (V_{MD}) in the machine direction (MD) is greater than the stretch factor (V_{TD}) in the transverse direction (TD);
wherein the film has a second temperature (T2) of greater than 120° C. and less than 180° C., preferably greater than 130° C. and less than 170° C., in particular greater than 140° C. and less than 160° C., during stretching; and the film having a third temperature (T3) of greater than 60° C. and less than 200° C., preferably greater than 80° C. and less than 180° C., in particular greater than 100° C. and less than 160° C., during thermofixing.
2. A method for producing a single- or multi-layered film, the method comprising at least the following steps:
   a step of extruding one layer or co-extruding several layers, whereby an extruded film is obtained;
   a step of simultaneous biaxial stretching of the extruded film; and
   a step of thermofixing the stretched film;
   wherein the film comprises a first polyethylene (PE1);
   wherein the first polyethylene (PE1) has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09;
   wherein the film contains the first polyethylene (PE1) in a mass fraction of greater than 30%, preferably greater than 40%, preferably greater than 50%, preferably greater than 65%, preferably greater than 80%, in particular greater than 90%, relative to the total mass of the film;
   wherein the film does not contain any of the following polymers, selected from the group, consisting of polyethylene terephthalate (PET), polyvinylidene chloride (PVDC) and polyamide (PA);
   wherein the film is cooled to a first temperature (T1) of below 20° C., preferably below 15° C., in particular below 10° C., within a time period of from 0.01 to 1 second, preferably from 0.05 to 0.5 seconds, in particular from 0.07 to 0.3 seconds, after extruding;
   wherein the stretch factor (V_{MD}) in the machine direction (MD) is greater than the stretch factor (V_{TD}) in the transverse direction (TD);
   wherein the film has a second temperature (T2) of greater than 120° C. and less than 180° C., preferably greater than 130° C. and less than 170° C., in particular greater than 140° C. and less than 160° C., during stretching;
   wherein the film is heated from the first temperature (T1) to the second temperature (T2) within a time period of 1 to 18 seconds, preferably 1.5 to 12 seconds, in particular 2 to 9 seconds, before stretching;
   wherein a time period (Δt) (=t2-t1) between a first time (T1) at which the film reaches the second temperature (T2) and a second time (T2) at which the stretching of the film begins is 0.05 to 6 seconds, preferably 0.1 to 3 seconds, in particular 0.3 to 1.5 seconds;
   wherein the film has a third temperature (T3) of greater than 60° C. and less than 200° C., preferably greater than 80° C. and less than 180° C., in particular greater than 100° C. and less than 160° C., during the thermofixing; and
   wherein a dwell time during the thermofixing (=duration of the thermofixing of the film), during which the film has the third temperature (T3), is greater than 1 second and less than 60 seconds, preferably greater than 2 seconds and less than 45 seconds, in particular greater than 3 seconds and less than 30 seconds.
3. A method for producing a single- or multi-layered film, the method comprising at least the following steps:
   a step of extruding one layer or co-extruding several layers, whereby an extruded film is obtained;
   a step of simultaneous biaxial stretching of the extruded film; and
   a step of thermofixing the stretched film;
   wherein the film contains a first polyethylene (PE1) in a mass fraction of greater than 30%, preferably greater than 40%, preferably greater than 50%, preferably greater than 65%, preferably greater than 80%, in particular greater than 90%, relative to the total mass of the film;
   wherein the first polyethylene (PE1) has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09;
   wherein the film does not contain any of the following polymers, selected from the group, consisting of polyethylene terephthalate (PET), polyvinylidene chloride (PVDC) and polyamide (PA);
   wherein the film is cooled to a first temperature (T1) of below 20° C., preferably below 15° C., in particular below 10° C., within a time period of from 0.01 to 1 second, preferably from 0.05 to 0.5 seconds, in particular from 0.07 to 0.3 seconds, after extruding;
   wherein a stretch factor (V_{MD}) in the machine direction or longitudinal direction (MD) is greater than 5.0, preferably greater than 6.0, in particular greater than 7.0, and less than 8.0;
   wherein a stretch factor (V_{TD}) in the transverse direction or transverse direction (TD) is greater than 4.0, preferably greater than 5.0, in particular greater than 6.0, and less than 7.0;
   wherein the stretch factor (V_{MD}) in the machine direction (MD) is greater than the stretch factor (V_{TD}) in the transverse direction (TD);
   wherein the film has a second temperature (T2) of greater than 120° C. and less than 180° C., preferably greater than 130° C. and less than 170° C., in particular greater than 140° C. and less than 160° C., during stretching;
   wherein the film is heated from the first temperature (T1) to the second temperature (T2) within a time period of 1 to 18 seconds, preferably 1.5 to 12 seconds, in particular 2 to 9 seconds, before stretching;
   wherein a time period (Δt) (=t2−t1) between a first time (T1) at which the film reaches the second temperature (T2) and a second time (T2) at which the stretching of the film begins is 0.05 to 3 seconds, preferably 0.1 to 3 seconds, in particular 0.3 to 1.5 seconds;
   wherein the film has a third temperature (T3) of greater than 60° C. and less than 200° C., preferably greater than 80° C. and less than 180° C., in particular greater than 100° C. and less than 160° C., during the thermofixing; and
   wherein a dwell time during the thermofixing (=duration of the thermofixing of the film), during which the film has the third temperature (T3), is greater than 2 seconds and less than 60 seconds, preferably greater than 3 seconds and less than 45 seconds, in particular greater than 4 seconds and less than 30 seconds.
4. The method according to any one of items 1 to 3, wherein the method further comprises relaxing the film during the thermofixing of the film;
   wherein a relaxation factor (R_{MD}) in the machine direction (MD) is greater than 0.00 and less than 0.10, preferably greater than 0.00 and less than 0.05, in particular greater than 0.00 and less than 0.03;
   wherein a relaxation factor (R_{TD}) in the transverse direction (TD) is greater than 0.00 and less than 0.20, preferably greater than 0.00 and less than 0.10, in particular greater than 0.00 and less than 0.05; and
   wherein the relaxation factor (R_{TD}) in the transverse direction (TD) is greater than the relaxation factor (R_{MD}) in the machine direction (MD).
5. The method according to item 4, wherein the film has the third temperature (T3) during the relaxation; and
   wherein a duration of the relaxation of the film, during which the film has the third temperature (T3), is greater than 2 seconds, preferably greater than 3 seconds, in particular greater than 4 seconds, and less than 45 seconds, preferably less than 30 seconds.
6. The method according to any one of items 1 to 5, wherein the method further provides for cooling the film after stretching and before thermofixation;
   wherein the film is cooled to a fourth temperature (T4) of below 50° C., preferably below 40° C., in particular below 30° C., within a time period of from 0.01 to 1 second, preferably from 0.05 to 0.5 seconds, in particular from 0.07 to 0.3 seconds, after stretching.
7. The method according to any one of items 1 to 6, wherein the film comprises a first polypropylene (PP1); and
   wherein the first polypropylene (PP1) has a heat deflection temperature of greater than 75° C., preferably greater than 85° C., in particular greater than 95° C., measured according to ASTM D648-18.
8. The method according to any one of items 1 to 7, wherein the film is multi-layered;
   wherein the film has at least one layer, preferably an outer layer and/or an inner layer, which contains or consists of a second polyethylene (PE2);
   wherein the second polyethylene (PE2) is a polyethylene (PE) with a density of less than 0.94 g/cm³, preferably less than 0.92 g/cm³, and greater than 0.87 g/cm³, measured according to DIN EN ISO 1183-1:2019-09.
9. The method according to one of items 1 to 8, wherein the film is multi-layered;
   wherein the film comprises at least one layer, preferably an outer layer and/or an inner layer, which contains or consists of a third polyethylene (PE3) and/or a third polypropylene (PP3);
   wherein the third polyethylene (PE3) has a density which is lower than the density of the first polyethylene (PE1) and higher than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).
10. The method according to any one of items 1 to 9, wherein the film is multi-layered;
   wherein the film contains ethylene-vinyl alcohol copolymer (EVOH) in a mass fraction of less than or equal to 5%, preferably less than 5%, based on the total mass of the film;
   wherein the film has at least one intermediate layer which contains or consists of ethylene-vinyl alcohol copolymer (EVOH);
   wherein the at least one intermediate layer containing ethylene-vinyl alcohol copolymer (EVOH) does not contain polyethylene (PE) or polypropylene (PP); and
   wherein preferably the intermediate layer, which contains ethylene-vinyl alcohol copolymer (EVOH) or consists of ethylene-vinyl alcohol copolymer (EVOH), is surrounded on both sides by layers which each contain an adhesion promoter (HV).
11. The method according to one of the items 1 to 10, wherein the film is multi-layered;
   wherein the film contains polyvinyl alcohol (PVOH) in a mass fraction of less than or equal to 5%, preferably less than 5%, relative to the total mass of the film;
   wherein the film has at least one intermediate layer which contains or consists of polyvinyl alcohol (PVOH);
   wherein the at least one intermediate layer containing polyvinyl alcohol (PVOH) does not contain polyethylene (PE) or polypropylene (PP); and
   wherein preferably the intermediate layer which contains polyvinyl alcohol (PVOH) or consists of polyvinyl alcohol (PVOH) is surrounded on both sides by layers which each contain an adhesion promoter (HV).
12. The method according to one of items 1 to 9, wherein the film does not contain ethylene-vinyl alcohol copolymer (EVOH) or polyvinyl alcohol (PVOH).
13. The method according to any one of items 1 to 9, wherein the film comprises an outer layer and an inner layer;
   wherein the outer layer does not contain ethylene-vinyl alcohol copolymer (EVOH) or polyvinyl alcohol (PVOH); and
   wherein the inner layer does not contain ethylene-vinyl alcohol copolymer (EVOH) or polyvinyl alcohol (PVOH).
14. The method according to any one of items 1 to 13, wherein the film does not contain any of the following polymers, selected from the group, consisting of polyethylene terephthalate (PET), polyvinylidene chloride (PVDC) and polyamide (PA).
15. The method according to any one of items 1 to 14, wherein the film is multi-layered;
   wherein the film comprises at least one layer consisting of the first polyethylene (PE1) and at least one layer consisting of the second polyethylene (PE2); or
   wherein the film comprises at least one layer consisting of the first polyethylene (PE1) and at least one layer consisting of the third polyethylene (PE3) and/or the third polypropylene (PP3); or
   wherein the film comprises at least one layer consisting of the first polyethylene (PE1) and at least one layer consisting of the second polyethylene (PE2) and at least one layer consisting of the third polyethylene (PE3) and/or of the third polypropylene (PP3).
16. The method according to any one of items 1 to 15, wherein the film is multi-layered;
   wherein the film comprises at least one layer consisting of the first polypropylene (PP1) and at least one layer consisting of the second polyethylene (PE2); or
   wherein the film comprises at least one layer consisting of the first polypropylene (PP1) and at least one layer consisting of the third polyethylene (PE3) and/or of the third polypropylene (PP3); or
   wherein the film comprises at least one layer consisting of the first polypropylene (PP1) and at least one layer consisting of the second polyethylene (PE2) and at least one layer consisting of the third polyethylene (PE3) and/or of the third polypropylene (PP3).
17. The method according to any one of items 1 to 16, wherein the film is multi-layered;
   wherein the film comprises at least one layer comprising or consisting of the first polyethylene (PE1); and
   wherein the film comprises at least one layer containing or consisting of ethylene-vinyl alcohol copolymer (EVOH) and/or polyvinyl alcohol (PVOH).
18. The method according to any one of items 1 to 17, wherein the film is multi-layered;
   wherein the film comprises at least one layer comprising or consisting of the first polyethylene (PE1);
   wherein the film comprises at least one layer containing or consisting of the second polyethylene (PE2); and
   wherein the film comprises at least one layer containing or consisting of ethylene-vinyl alcohol copolymer (EVOH) and/or polyvinyl alcohol (PVOH).
19. The method according to any one of items 1 to 18, wherein the film is multi-layered;
   wherein the film comprises at least one layer comprising or consisting of the first polyethylene (PE1);
   wherein the film comprises at least one layer comprising or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
20. The method according to any one of items 1 to 19, wherein the film is multi-layered;
   wherein the film comprises at least one layer comprising or consisting of the first polyethylene (PE1);
   wherein the film has at least one layer containing or consisting of the second polyethylene (PE2);
   wherein the film comprises at least one layer containing or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
21. The method according to any one of items 1 to 20, wherein the film is multi-layered;
   wherein the film comprises at least one layer comprising or consisting of the first polypropylene (PP1); and
   wherein the film comprises at least one layer containing or consisting of ethylene-vinyl alcohol copolymer (EVOH) and/or polyvinyl alcohol (PVOH).
22. The method according to any one of items 1 to 21, wherein the film is multi-layered;
   wherein the film comprises at least one layer comprising or consisting of the first polypropylene (PP1);
   wherein the film comprises at least one layer comprising or consisting of the second polyethylene (PE2); and
   wherein the film comprises at least one layer containing or consisting of ethylene-vinyl alcohol copolymer (EVOH) and/or polyvinyl alcohol (PVOH).
23. The method according to any one of items 1 to 22, wherein the film is multi-layered;
   wherein the film comprises at least one layer comprising or consisting of the first polypropylene (PP1);
   wherein the film comprises at least one layer comprising or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
24. The method according to any one of items 1 to 23, wherein the film is multi-layered;
   wherein the film comprises at least one layer comprising or consisting of the first polypropylene (PP1);
   wherein the film comprises at least one layer comprising or consisting of the second polyethylene (PE2);
   wherein the film comprises at least one layer containing or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
25. The method according to any one of items 1 to 24, wherein the method does not comprise a step of laminating or extrusion coating the film or components thereof, in particular layers of the film; and/or wherein the film is multi-layered and the co-extruding of the multi-layered film is performed in a single step.
26. The method according to any one of items 1 to 25, wherein the film is multi-layered;
   wherein the film comprises at least an outer layer and/or an inner layer, preferably an inner layer, comprising or consisting of a second polymer (PM2), preferably a second polyolefin (PO2);
   wherein the second polymer (PM2), preferably the second polyolefin (PO2), is preferably sealable, in particular heat-sealable, and preferably comprises or consists of a polyethylene (PE), a polypropylene (PP), an ethylene-vinyl acetate copolymer (EVA), an ionomer (IO), an ethylene-methyl methacrylate copolymer (EMMA), an ethylene-methacrylic acid copolymer (EMA) or any mixture thereof.
27. The method according to any one of items 1 to 26, wherein the film is multi-layered;
   wherein the film comprises at least an outer layer and/or an inner layer, preferably an outer layer, comprising or consisting of a third polymer (PM3), preferably a third polyolefin (PO3);
   wherein the third polymer (PM3), preferably the third polyolefin (PO3), is preferably not sealable, more preferably not heat-sealable, in particular has a sealing temperature which is higher than the sealing temperature of the second polymer (PM2), preferably the second polyolefin (PO2), and preferably contains or consists of a polyethylene (PE) and/or a polypropylene (PP) or any mixture thereof.
28. A single- or multi-layered, extruded, simultaneously biaxially stretched and thermofixed film, preferably produced by the method according to any one of items 1 to 27,
   wherein the film comprises a first polyethylene (PE1);
   wherein the first polyethylene (PE1) has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09;
   wherein the film contains the first polyethylene (PE1) in a mass fraction of greater than 30%, preferably greater than 40%, preferably greater than 50%, preferably greater than 65%, preferably greater than 80%, in particular greater than 90%, relative to the total mass of the film; and
   wherein the film does not contain any of the following polymers, selected from the group, consisting of polyethylene terephthalate (PET), polyvinylidene chloride (PVDC) and polyamide (PA).
29. A single- or multi-layered, extruded, simultaneously biaxially stretched and thermofixed film, preferably produced by the method according to any one of items 1 to 27,
   wherein the film comprises a first polyethylene (PE1);
   wherein the first polyethylene (PE1) has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09;
   wherein the film contains the first polyethylene (PE1) in a mass fraction of greater than 40%, preferably greater than 50%, preferably greater than 65%, preferably greater than 80%, in particular greater than 90%, relative to the total mass of the film; and
   wherein the film does not contain any of the following polymers, selected from the group, consisting of polyethylene terephthalate (PET), polyvinylidene chloride (PVDC) and polyamide (PA).
30. The film according to item 28 or 29, wherein the film is not laminated.
31. The film according to any one of items 28 to 30, wherein the film is relaxed;
   wherein a residual stretch factor (RV_{MD}) of the film in the machine direction (MD) is greater than 5.0 and less than 7.0, preferably greater than 5.5 and less than 7.0, in particular greater than 6.0 and less than 7.0;
   wherein a residual stretch factor (RV_{TD}) of the film in the transverse direction (TD) is greater than 4.0 and less than 6.0, preferably greater than 4.5 and less than 6.0, in particular greater than 5.0 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed;
   wherein a residual stretch factor (RV_{MD}) of the film in the machine direction (MD) is greater than 5.0 and less than 7.0, and a residual stretch factor (RV_{TD}) of the film in the transverse direction (TD) is greater than 4.0 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed;
   wherein a residual stretch factor (RV_{MD}) of the film in the machine direction (MD) is greater than 5.5 and less than 7.0, and a residual stretch factor (RV_{TD}) of the film in the transverse direction (TD) is greater than 4.5 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed;
   wherein a residual stretch factor (RV_{MD}) of the film in the machine direction (MD) is greater than 6.0 and less than 7.0, and a residual stretch factor (RV_{TD}) of the film in the transverse direction (TD) is greater than 5.0 and less than 6.0; and
   wherein the residual stretch factor (RV_{MD}) of the film in the machine direction (MD) is greater than the residual stretch factor (RV_{TD}) in the transverse direction (TD).
32. The film according to any one of items 28 to 30,
   wherein the film is relaxed and the first polyethylene (PE1) has a density greater than 0.960 g/cm³;
   wherein a residual stretch factor (RV_{MD}) of the film in the machine direction (MD) is greater than 3.6 and less than 3.9, preferably greater than 4.1 and less than 4.4, in particular greater than 5.0 and less than 5.4;
   wherein a residual stretch factor (RV_{TD}) of the film in the transverse direction (TD) is greater than 2.8 and less than 3.4, preferably greater than 3.6 and less than 3.9, in particular greater than 4.1 and less than 4.4; and
   wherein the residual stretch factor (RV_{MD}) of the film in the machine direction (MD) is greater than the residual stretch factor (RV_{TD}) in the transverse direction (TD); or
   wherein the film is relaxed and the first polyethylene (PE1) has a density greater than 0.960 g/cm³;
   wherein a residual stretch factor (RV_{MD}) of the film in the machine direction (MD) is greater than 3.6 and less than 3.9, and a residual stretch factor (RV_{TD}) of the film in the transverse direction (TD) is greater than 2.8 and less than 3.4; and
   wherein the residual stretch factor (RV_{MD}) of the film in the machine direction (MD) is greater than the residual stretch factor (RV_{TD}) in the transverse direction (TD); or
   wherein the film is relaxed and the first polyethylene (PE1) has a density greater than 0.960 g/cm³;
   wherein a residual stretch factor (RV_{MD}) of the film in the machine direction (MD) is greater than 4.1 and less than 4.4, and a residual stretch factor (RV_{TD}) of the film in the transverse direction (TD) is greater than 3.6 and less than 3.9; and
   wherein the residual stretch factor (RV_{MD}) of the film in the machine direction (MD) is greater than the residual stretch factor (RV_{TD}) in the transverse direction (TD); or
   wherein the film is relaxed and the first polyethylene (PE1) has a density greater than 0.960 g/cm³;
   wherein a residual stretch factor (RV_{MD}) of the film in the machine direction (MD) is greater than 5.0 and less than 5.4, and a residual stretch factor (RV_{TD}) of the film in the transverse direction (TD) is greater than 4.1 and less than 4.4, and
   wherein the residual stretch factor (RV_{MD}) of the film in the machine direction (MD) is greater than the residual stretch factor (RV_{TD}) in the transverse direction (TD).
33. The film according to any one of items 28 to 30,
   wherein the film is relaxed and the first polyethylene (PE1) has a density greater than 0.940 g/cm³ and less than or equal to 0.960 g/cm³;
   wherein a residual stretch factor (RV_{MD}) of the film in the machine direction (MD) is greater than 5.0 and less than 7.0, preferably greater than 5.5 and less than 7.0, in particular greater than 6.0 and less than 7.0;
   wherein a residual stretch factor (RV_{TD}) of the film in the transverse direction (TD) is greater than 4.0 and less than 6.0, preferably greater than 4.5 and less than 6.0, in particular greater than 5.0 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed and the first polyethylene (PE1) has a density greater than 0.940 g/cm³ and less than or equal to 0.960 g/cm³;
   wherein a residual stretch factor (RV_{MD}) of the film in the machine direction (MD) is greater than 5.0 and less than 7.0, and a residual stretch factor (RV_{TD}) of the film in the transverse direction (TD) is greater than 4.0 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed and the first polyethylene (PE1) has a density greater than 0.940 g/cm³ and less than or equal to 0.960 g/cm³;
   wherein a residual stretch factor (RV_{MD}) of the film in the machine direction (MD) is greater than 5.5 and less than 7.0, and a residual stretch factor (RV_{TD}) of the film in the transverse direction (TD) is greater than 4.5 and less than 6.0; and
   wherein the residual stretch factor (RV_{MD}) of the film in the machine direction (MD) is greater than the residual stretch factor (RV_{TD}) in the transverse direction (TD); or
   wherein the film is relaxed and the first polyethylene (PE1) has a density greater than 0.940 g/cm³ and less than or equal to 0.960 g/cm³;
   wherein a residual stretch factor (RV_{MD}) of the film in the machine direction (MD) is greater than 6.0 and less than 7.0, and a residual stretch factor (RV_{TD}) of the film in the transverse direction (TD) is greater than 5.0 and less than 6.0, and
   wherein the residual stretch factor (RV_{MD}) of the film in the machine direction (MD) is greater than the residual stretch factor (RV_{TD}) in the transverse direction (TD).
34. The film according to any one of items 28 to 33, wherein the film comprises a first polypropylene (PP1); and
   wherein the first polypropylene (PP1) has a heat deflection temperature of greater than 75° C., preferably greater than 85° C., in particular greater than 95° C., measured according to ASTM D648-18.
35. The film according to any one of items 28 to 34, wherein the film is multi-layered;
   wherein the film comprises at least one layer, preferably an outer layer and/or an inner layer, which comprises or consists of a second polyethylene (PE2);
   wherein the second polyethylene (PE2) is a polyethylene (PE) with a density of less than 0.94 g/cm³, preferably less than 0.92 g/cm³, and greater than 0.87 g/cm³, measured according to DIN EN ISO 1183-1:2019-09.
36. The film according to any one of items 28 to 35, wherein the film is multi-layered;
   wherein the film comprises at least one layer, preferably an outer layer and/or an inner layer, which comprises or consists of a third polyethylene (PE3) and/or a third polypropylene (PP3);
   wherein the third polyethylene (PE3) has a density which is lower than the density of the first polyethylene (PE1) and higher than the density of the second polyethylene (PE2); and
   wherein the third polypropylene (PP3) has a heat deflection temperature which is lower than the heat deflection temperature of the first polypropylene (PP1) and higher than the heat deflection temperature of the second polypropylene (PP2).
37. The film according to any one of items 28 to 36, wherein the film is multi-layered;
   wherein the film contains ethylene-vinyl alcohol copolymer (EVOH) in a mass fraction of less than or equal to 5%, preferably less than 5%, based on the total mass of the film;
   wherein the film has at least one intermediate layer which contains or consists of ethylene-vinyl alcohol copolymer (EVOH);
   wherein the at least one intermediate layer containing ethylene-vinyl alcohol copolymer (EVOH) does not contain polyethylene (PE) or polypropylene (PP); and
   wherein preferably the intermediate layer, which contains ethylene-vinyl alcohol copolymer (EVOH) or consists of ethylene-vinyl alcohol copolymer (EVOH), is surrounded on both sides by layers which each contain an adhesion promoter (HV).
38. The film according to any one of items 28 to 36, wherein the film is multi-layered;
   wherein the film contains polyvinyl alcohol (PVOH) in a mass fraction of less than or equal to 5%, preferably less than 5%, relative to the total mass of the film;
   wherein the film has at least one intermediate layer which contains or consists of polyvinyl alcohol (PVOH);
   wherein the at least one intermediate layer containing polyvinyl alcohol (PVOH) does not contain polyethylene (PE) or polypropylene (PP); and
   wherein preferably the intermediate layer which contains polyvinyl alcohol (PVOH) or consists of polyvinyl alcohol (PVOH) is surrounded on both sides by layers which each contain an adhesion promoter (HV).
39. The film according to any one of items 28 to 36, wherein the film does not contain ethylene-vinyl alcohol copolymer (EVOH) or polyvinyl alcohol (PVOH).
40. The film according to any one of items 28 to 36, wherein the film comprises an outer layer and an inner layer;
   wherein the outer layer does not contain ethylene-vinyl alcohol copolymer (EVOH) or polyvinyl alcohol (PVOH); and
   wherein the inner layer does not contain ethylene-vinyl alcohol copolymer (EVOH) or polyvinyl alcohol (PVOH).
41. The film according to any one of items 28 to 40, wherein the film does not contain any of the following polymers, selected from the group, consisting of polyethylene terephthalate (PET), polyvinylidene chloride (PVDC) and polyamide (PA).
42. The film according to any one of items 28 to 41, wherein the film is multi-layered;
   wherein the film comprises at least one layer consisting of the first polyethylene (PE1) and at least one layer consisting of the second polyethylene (PE2); or
   wherein the film comprises at least one layer consisting of the first polyethylene (PE1) and at least one layer consisting of the third polyethylene (PE3) and/or the third polypropylene (PP3); or
   wherein the film comprises at least one layer consisting of the first polyethylene (PE1) and at least one layer consisting of the second polyethylene (PE2) and at least one layer consisting of the third polyethylene (PE3) and/or of the third polypropylene (PP3).
43. The film according to any one of items 28 to 42, wherein the film is multi-layered;
   wherein the film comprises at least one layer consisting of the first polypropylene (PP1) and at least one layer consisting of the second polyethylene (PE2); or
   wherein the film comprises at least one layer consisting of the first polypropylene (PP1) and at least one layer consisting of the third polyethylene (PE3) and/or of the third polypropylene (PP3); or
   wherein the film comprises at least one layer consisting of the first polypropylene (PP1) and at least one layer consisting of the second polyethylene (PE2) and at least one layer consisting of the third polyethylene (PE3) and/or of the third polypropylene (PP3).
44. The film according to any one of items 28 to 43, wherein the film is multi-layered;
   wherein the film comprises at least one layer comprising or consisting of the first polyethylene (PE1); and
   wherein the film comprises at least one layer containing or consisting of ethylene-vinyl alcohol copolymer (EVOH) and/or polyvinyl alcohol (PVOH).
45. The film according to any one of items 28 to 44, wherein the film is multi-layered;
   wherein the film comprises at least one layer comprising or consisting of the first polyethylene (PE1);
   wherein the film comprises at least one layer comprising or consisting of the second polyethylene (PE2); and
   wherein the film comprises at least one layer containing or consisting of ethylene-vinyl alcohol copolymer (EVOH) and/or polyvinyl alcohol (PVOH).
46. The film according to any one of items 28 to 45, wherein the film is multi-layered;
   wherein the film comprises at least one layer comprising or consisting of the first polyethylene (PE1);
   wherein the film comprises at least one layer comprising or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
47. The film according to any one of items 28 to 46, wherein the film is multi-layered;
   wherein the film comprises at least one layer comprising or consisting of the first polyethylene (PE1);
   wherein the film comprises at least one layer comprising or consisting of the second polyethylene (PE2);
   wherein the film comprises at least one layer containing or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
48. The film according to any one of items 28 to 47, wherein the film is multi-layered;
   wherein the film comprises at least one layer comprising or consisting of the first polypropylene (PP1); and
   wherein the film comprises at least one layer containing or consisting of ethylene-vinyl alcohol copolymer (EVOH) and/or polyvinyl alcohol (PVOH).
49. The film according to any one of items 28 to 48, wherein the film is multi-layered;
   wherein the film comprises at least one layer comprising or consisting of the first polypropylene (PP1);
   wherein the film comprises at least one layer comprising or consisting of the second polyethylene (PE2); and
   wherein the film comprises at least one layer containing or consisting of ethylene-vinyl alcohol copolymer (EVOH) and/or polyvinyl alcohol (PVOH).
50. The film according to any one of items 28 to 49, wherein the film is multi-layered;
   wherein the film comprises at least one layer comprising or consisting of the first polypropylene (PP1);
   wherein the film comprises at least one layer comprising or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
51. The film according to any one of items 28 to 50, wherein the film is multi-layered;
   wherein the film comprises at least one layer comprising or consisting of the first polypropylene (PP1);
   wherein the film comprises at least one layer comprising or consisting of the second polyethylene (PE2);
   wherein the film comprises at least one layer containing or consisting of the third polyethylene (PE3) and/or the third polypropylene (PP3); and
   wherein the film comprises at least one layer containing or consisting of ethylene-vinyl alcohol copolymer (EVOH) and/or polyvinyl alcohol (PVOH).
52. The film according to any one of items 28 to 51, wherein the film consists of a single layer consisting of the first polyethylene (PE1); or
   wherein the film consists of several, preferably two, three, four or five, layers, each consisting of the first polyethylene (PE1).
53. The film according to any one of items 28 to 52, wherein the film is multi-layered;
   wherein the film comprises at least an outer layer and/or an inner layer, preferably an inner layer, comprising or consisting of a second polymer (PM2), preferably a second polyolefin (PO2);
   wherein the second polymer (PM2), preferably the second polyolefin (PO2), is preferably sealable, in particular heat-sealable, and preferably comprises or consists of a polyethylene (PE), a polypropylene (PP), an ethylene-vinyl acetate copolymer (EVA), an ionomer (IO), an ethylene-methyl methacrylate copolymer (EMMA), an ethylene-methacrylic acid copolymer (EMA) or any mixture thereof.
54. The film according to any one of items 28 to 52, wherein the film is multi-layered;
   wherein the film comprises at least an outer layer and/or an inner layer, preferably an outer layer, comprising or consisting of a third polymer (PM3), preferably a third polyolefin (PO3);
   wherein the third polymer (PM3), preferably the third polyolefin (PO3), is preferably not sealable, more preferably not heat-sealable, in particular has a sealing temperature which is higher than the sealing temperature of the second polymer (PM2), preferably of the second polyolefin (PO2), and preferably comprises or consists of a polyethylene (PE) and/or a polypropylene (PP) or any mixture thereof.
55. The film according to any one of items 28 to 54, wherein the film has an outer layer which consists of a first polypropylene PP1;
   wherein the film has an inner layer which consists of the first polyethylene PE1, a second polyethylene PE2 or a third polyethylene PE3;
   wherein the first polypropylene PP1 has a heat deflection temperature of greater than 75° C., preferably greater than 85° C., in particular greater than 95° C., measured according to ASTM D648-18;
   wherein the second polyethylene PE2 has a density of less than 0.940 g/cm³, preferably less than 0.920 g/cm³, and greater than 0.870 g/cm³, measured according to DIN EN ISO 1183-1:2019-09; and
   wherein the third polyethylene PE3 has a density which is less than the density of the first polyethylene PE1 and greater than the density of the second polyethylene PE2, in each case measured according to DIN EN ISO 1183-1:2019-09.
56. The film according to any one of items 28 to 55, wherein the film is multi-layered;
   wherein the film contains ethylene-vinyl alcohol copolymer (EVOH) in a mass fraction of less than 5%, based on the total mass of the film; and
   wherein the film has at least one layer which consists of ethylene-vinyl alcohol copolymer (EVOH); or
   wherein the film is multi-layered;
   wherein the film contains polyvinyl alcohol copolymer (PVOH) in a mass fraction of less than 5%, based on the total mass of the film; and
   wherein the film comprises at least one layer consisting of polyvinyl alcohol copolymer (PVOH).
57. A use of a first polyethylene (PE1) for a single- or multi-layered, extruded, simultaneously biaxially stretched and thermofixed film, preferably for a film according to any one of items 28 to 56, or for the manufacture thereof;
   wherein the film contains the first polyethylene (PE1) in a mass fraction of greater than 30%, preferably greater than 40%, preferably greater than 50%, preferably greater than 65%, preferably greater than 80%, in particular greater than 90%, relative to the total mass of the film;
   wherein the first polyethylene (PE1) has a density of greater than 0.940 g/cm³, preferably greater than 0.950 g/cm³, in particular greater than 0.960 g/cm³, and less than or equal to 1.010 g/cm³, preferably less than 1.000 g/cm³, in particular less than 0.970 g/cm³, measured according to DIN EN ISO 1183-1:2019-09; and
   wherein the film does not contain any of the following polymers, selected from the group, consisting of polyethylene terephthalate (PET), polyvinylidene chloride (PVDC) and polyamide (PA).
58. The use according to item 57, wherein the film comprises a first polypropylene (PP1); and
   wherein the first polypropylene (PP1) has a heat deflection temperature of greater than 75° C., preferably greater than 85° C., in particular greater than 95° C., measured according to ASTM D648-18.
59. A use of a film according to any of items 28 to 56 as a ready-to-use packaging material for foodstuffs or for producing a ready-to-use packaging material for foodstuffs by laminating on a further polymer layer or several further polymer layers or a package of several polymer layers.

What is claimed is:

1. A method for producing a single- or multi-layered film, the method comprising at least the following steps:
a step of extruding one layer or co-extruding a plurality of layers, thereby obtaining an extruded film;
a step of simultaneous biaxial stretching of the extruded film; and
a step of thermofixing the stretched film;
wherein the film comprises a first polyethylene;
wherein the first polyethylene has a density of greater than 0.940 g/cm³ and less than or equal to 1.010 g/cm³ measured according to DIN EN ISO 1183-1:2019-09;
wherein the film contains the first polyethylene in a mass fraction of greater than 30% relative to a total mass of the film;
wherein the film does not contain any of the following polymers, selected from the group, consisting of polyethylene terephthalate, polyvinylidene chloride, and polyamide;
wherein a stretch factor in a machine direction is greater than a stretch factor in a transverse direction;
wherein the film has a second temperature of greater than 120° C. and less than 180° C. during stretching; and
wherein the film has a third temperature of greater than 60° C. and less than 200° C., during thermofixing.

2. The method according to claim 1, wherein the film is cooled to a first temperature of below 20° C. within a time period of from 0.01 to 1 second after extruding;
wherein the film is heated from the first temperature to the second temperature within a time period of 1 to 18 seconds before stretching;
wherein a time period between a first time point at which the film reaches the second temperature and a second time point at which the stretching of the film begins is 0.05 to 6 seconds; and
wherein a dwell time during the thermofixing, during which the film has the third temperature, is greater than 1 second and less than 60 seconds the dwell time during thermofixing is the duration of the thermofixing of the film.

3. The method according to claim 1, wherein the stretch factor in the machine direction is greater than 5.0, and less than 8.0;
wherein the stretch factor in the transverse direction is greater than 4.0 and less than 7.0; and
wherein a dwell time during the thermofixing, during which the film has the third temperature, is greater than 2 seconds and less than 60 seconds the dwell time during the thermofixing is the duration of the thermofixing of the film.

4. The method according to claim 1, wherein the method further comprises relaxing the film during the thermofixing of the film;
wherein a relaxation factor in the machine direction is greater than 0.00 and less than 0.10;
wherein a relaxation factor in the transverse direction is greater than 0.00 and less than 0.20; and
wherein the relaxation factor in the transverse direction is greater than the relaxation factor in the machine direction.

5. The method according to claim 4, wherein the film has the third temperature during the relaxation; and
wherein a duration of the relaxation of the film, during which the film has the third temperature, is greater than 2 seconds and less than 45 seconds.

6. The method according to claim 1, wherein the method further comprises cooling the film after stretching and before thermofixation;
wherein the film is cooled to a fourth temperature of below 50° C. within a time period of from 0.01 to 1 second after stretching.

7. The method according to claim 1, wherein the method does not comprise a step of laminating or extrusion coating of the film or layers of the film; and/or
wherein the film is multi-layered and co-extruding of the multi-layered film is performed in a single step.

8. A single- or multi-layered, extruded, simultaneously biaxially stretched and thermofixed film, produced by the method according to claim 1,
wherein the film comprises a first polyethylene;
wherein the first polyethylene has a density of greater than 0.940 g/cm³ and less than or equal to 1.010 g/cm³ measured according to DIN EN ISO 1183-1:2019-09;
wherein the film contains the first polyethylene in a mass fraction of greater than 30% relative to the total mass of the film; and
wherein the film does not contain any of the following polymers, selected from the group, consisting of polyethylene terephthalate, polyvinylidene chloride, and polyamide.

9. The film according to claim 8, wherein the film is not laminated.

10. The film according to claim 8, wherein the film is relaxed;
wherein a residual stretch factor of the film in the machine direction is greater than 5.0 and less than 7.0;
wherein a residual stretch factor of the film in the transverse direction is greater than 4.0 and less than 6.0; and
wherein the residual stretch factor of the film in the machine direction is greater than the residual stretch factor in the transverse direction.

11. The film according to claim 8, wherein the film is relaxed and the first polyethylene has a density greater than 0.960 g/cm³;
wherein a residual stretch factor of the film in the machine direction is greater than 3.6 and less than 3.9;
wherein a residual stretch factor of the film in the transverse direction is greater than 2.8 and less than 3.4; and
wherein the residual stretch factor of the film in the machine direction is greater than the residual stretch factor in the transverse direction.

12. The film according to claim 8, wherein the film is relaxed and the first polyethylene has a density greater than 0.940 g/cm³ and less than or equal to 0.960 g/cm³;
wherein a residual stretch factor of the film in the machine direction is greater than 5.0 and less than 7.0;
wherein a residual stretch factor of the film in the transverse direction is greater than 4.0 and less than 6.0; and
wherein the residual stretch factor of the film in the machine direction is greater than the residual stretch factor in the transverse direction.

13. The film according to claim 8, wherein the film consists of a single layer consisting of the first polyethylene; or
wherein the film consists of at least two layers.

14. The film according to claim 8, wherein the film is multi-layered;
wherein the film comprises an inner layer comprising a second polymer;
wherein the second polymer is sealable and comprises a polyethylene, a polypropylene, an ethylene-vinyl acetate copolymer, an ionomer, an ethylene-methyl methacrylate copolymer, an ethylene-methacrylic acid copolymer or any mixture thereof.

15. The film according to claim 14, wherein the film is multi-layered;
wherein the film comprises at least an outer layer comprising a third polymer;
wherein the third polymer has a sealing temperature which is higher than a sealing temperature of the second polymer and comprises a polyethylene and/or a polypropylene or any mixture thereof.

16. The film according to claim 8, wherein the film comprises an outer layer consisting of a first polypropylene;
wherein the film comprises an inner layer which consists of the first polyethylene, a second polyethylene or a third polyethylene;
wherein the first polypropylene has a heat deflection temperature of greater than 75° C. measured according to ASTM D648-18;
wherein the second polyethylene has a density of less than 0.940 g/cm³ measured according to DIN EN ISO 1183-1:2019-09; and
wherein the third polyethylene has a density which is less than the density of the first polyethylene and greater than the density of the second polyethylene, in each case measured according to DIN EN ISO 1183-1:2019-09.

17. The film according to claim 8, wherein the film is multi-layered;
wherein the film contains ethylene-vinyl alcohol copolymer in a mass fraction of less than 5%, based on the total mass of the film; and
wherein the film has at least one layer which consists of ethylene-vinyl alcohol copolymer.

18. A use of a first polyethylene for a single- or multi-layered, extruded, simultaneously biaxially stretched and thermofixed film;
wherein the film contains the first polyethylene in a mass fraction of greater than 30% relative to a total mass of the film;
wherein the first polyethylene has a density of greater than 0.940 g/cm³ and less than or equal to 1.010 g/cm³ measured according to DIN EN ISO 1183-1:2019-09; and
wherein the film does not contain any of the following polymers, selected from the group, consisting of polyethylene terephthalate, polyvinylidene chloride, and polyamide.

19. A use of a film according to claim 8 as a ready-to-use packaging material for food or for producing a ready-to-use packaging material for food by laminating on a further polymer layer or several further polymer layers or a package of several polymer layers.

20. The film according to claim 8,
wherein the film is multi-layered;
wherein the film contains polyvinyl alcohol copolymer in a mass fraction of less than 5%, based on the total mass of the film; and
wherein the film comprises at least one layer consisting of polyvinyl alcohol copolymer.
